(19) United States
(12) Patent Application Publication
(10) Pub. No.: US 2019/0276321 A1
(43) Pub. Date: Sep. 12, 2019

(54) METHOD FOR PRODUCING OLIGOSILANE AND APPARATUS FOR PRODUCING OLIGOSILANE

(71) Applicant: SHOWA DENKO K.K., Tokyo (JP)

(72) Inventors: Kiyoshi NOMURA, Tokyo (JP); Hiroshi UCHIDA, Tokyo (JP)

(73) Assignee: SHOWA DENKO K.K., Tokyo (JP)

(21) Appl. No.: 16/345,014

(22) PCT Filed: Oct. 23, 2017
(86) PCT No.: PCT/JP2017/038181

§ 371 Date: Apr. 25, 2019

(30) Foreign Application Priority Data
Oct. 27, 2016 (JP) 2016-210810

(51) Int. Cl. C01B 33/04; B01J 20/18; B01J 20/28; B01J 29/48; B01J 37/02; B01J 37/08; B01J 8/06; B01D 53/22; B01D 53/04; B01D 69/02; B01D 71/02

(52) U.S. Cl. CPC C01B 33/046; B01D 2253/306; B01J 20/28016; B01J 29/48; B01J 37/0221; B01J 37/0244; B01J 37/0236; B01J 37/088; B01J 8/065; B01D 53/229; B01D 53/0423; B01D 69/02; B01D 71/02; C01P 2006/80; B01D 2253/108; B01D 2253/106; B01D 2257/108; B01J 20/186

(57) ABSTRACT

Provided is an oligosilane production method with which a target oligosilane can be selectively produced. A reaction-produced mixture fluid which contains an oligosilane obtained by the dehydrogenative coupling of a hydrosilane is supplied to a membrane separator under specific conditions and/or brought into contact with an adsorbent under specific conditions.

### TECHNICAL FIELD

The present invention relates to a method for producing an oligosilane and an apparatus for producing an oligosilane.

### BACKGROUND ART

Oligosilanes such as hexahydrodisilane (Si₂H₆, hereinafter may be abbreviated as “disilane”) and octahydrotrisilane (Si₃H₈, hereinafter may be abbreviated as “trisilane”) are highly reactive as compared with tetrahydrosilane (SiH₄, hereinafter may be abbreviated as “monosilane”) and very useful compounds as, for example, precursors for the formation of amorphous silicon and silicon films.

Conventionally, the following methods for producing oligosilanes, for example, have been reported: the acid decomposition of magnesium silicide (refer to Non-Patent Document 1), the reduction of hexachlorodisilane (refer to Non-Patent Document 2), electric discharge in tetrahydrosilane (refer to Patent Document 1), the thermal decomposition of silane (refer to Patent Documents 2 to 3), and the dehydrogenative coupling of silane using a catalyst (refer to Patent Documents 4 to 10).

### PRIOR ART DOCUMENT

### Patent Document

Patent Document 1: U.S. Pat. No. 5,478,453
Patent Document 2: Japanese Patent No. 4855462
Patent Document 3: Japanese Patent Application Laid-open No. H11-260729
Patent Document 4: Japanese Patent Application Laid-open No. H03-183613
Patent Document 5: Japanese Patent Application Laid-open No. H01-198631
Patent Document 6: Japanese Patent Application Laid-open No. H02-184513
Patent Document 7: Japanese Patent Application Laid-open No. H05-032785
Patent Document 8: Japanese Translation of PCT Application No. 2013-506541
Patent Document 9: WO2015/060189
Patent Document 10: WO2015/090996

### Non-Patent Document

Non-Patent Document 1: Hydrogen Compounds of Silicon. I. The Preparation of Mono- and Disilane, WARREN C. JOHNSON and SAMPSON ISENBERG, J. Am. Chem. Soc., 1935, 57, 1349.
Non-Patent Document 2: The Preparation and Some Properties of Hydrides of Elements of the Fourth Group of the Periodic System and of their Organic Derivatives, A. E. FINHOLT, A. C. BOND Jr., K. E. WILZBACH and H. I. SCHLESINGER, J. Am. Chem. Soc., 1947, 69, 2692.

### SUMMARY OF INVENTION

### Problem to be Solved by Invention

Although the oligosilane production method using the dehydrogenative coupling of tetrahydrosilane (SiH₄) is an industrially excellent method with which an oligosilane can be produced at a relatively low cost from the view point of using an inexpensive and readily available raw material, there is room for improvement with this method.

For instance, when it is intended to increase tetrahydrosilane conversion, polysilanes are also produced in addition to a target oligosilane. To suppress the polysilane production, the reaction is run such that the conversion is about from 10 to 15% in general and about 30% at the highest, and a thus obtained mixture of a raw material and a product is refined to provide the target oligosilane. Such refining requires a very large amount of energy.

An object of the present invention is to provide an oligosilane production method with which a target oligosilane can be more efficiently produced. Another object of the present invention is to provide an oligosilane production apparatus with which an oligosilane is more efficiently produced.

### Solution to Problem

As a result of extensive and intensive investigations directed to solving the problem identified above, the present inventors found out that oligosilanes can be efficiently condensed and consequently more efficiently produced by treating a reaction-produced mixture fluid which contains an oligosilane obtained by the dehydrogenative coupling of a hydrosilane, under specific conditions using a membrane separator and/or by bringing the reaction-produced mixture fluid into contact with an adsorbent under specific conditions. The present invention was achieved based on this finding. The present inventors also found that when the present invention is carried out as a continuous production method in which an unreacted raw material is directly recycled, it becomes easier to reuse unreacted tetrahydrosilane and the like, and oligosilane production can be carried out further efficiently as a whole.

That is, the present invention is as follows.

<1> A method for producing an oligosilane, comprising:

a first step of producing an oligosilane by dehydrogenative coupling of a hydrosilane; and

a second step of separating a reaction-produced mixture fluid obtained through the first step into a high raw-material content fluid and a high product content fluid by subjecting the reaction-produced mixture fluid to the following treatments (A) and/or (B), wherein

a molar concentration of an oligosilane with at least 2 and not more than 5 silicon atoms with respect to all silane compounds in the high raw-material content fluid is lower than a molar concentration of the oligosilane with at least 2 and not more than 5 silicon atoms with respect to all silane compounds in the reaction-produced mixture fluid, and

a molar concentration of the oligosilane with at least 2 and not more than 5 silicon atoms with respect to all silane compounds in the high product content fluid is higher than the molar concentration of the oligosilane with at least 2 and not more than 5 silicon atoms with respect to all silane compounds in the reaction-produced mixture fluid,

(A) supplying the reaction-produced mixture fluid to a membrane separator under conditions satisfying the following (a-1) to (a-3) to obtain the high raw-material content fluid as a fluid having permeated through a membrane and obtain the high product content fluid as a fluid having not permeated through the membrane:

(a-1) the membrane of the membrane separator is made of a zeolite, porous silica, alumina, or zirconia;

(a-2) the reaction-produced mixture fluid supplied to the membrane separator has a pressure of at least 0.1 MPa and not more than 10 MPa; and

(a-3) the reaction-produced mixture fluid supplied to the membrane separator has a temperature of at least −10° C. and less than 300° C., and

(B) bringing the reaction-produced mixture fluid into contact with an adsorbent under conditions satisfying the following (b-1) to (b-3) to obtain the high raw-material content fluid as a fluid having not been adsorbed to the adsorbent and obtain the high product content fluid as a fluid having been adsorbed to and subsequently desorbed from the adsorbent:

(b-1) the adsorbent is made of a zeolite, alumina gel, silica gel, or activated carbon;

(b-2) the reaction-produced mixture fluid brought into contact with the adsorbent has a pressure of at least 0.1 MPa and not more than 20 MPa; and

(b-3) the reaction-produced mixture fluid brought into contact with the adsorbent has a temperature of at least −50° C. and not more than 200° C.

<2> The method for producing an oligosilane according to <1>, wherein in the first step, the hydrosilane is tetrahydrosilane (SiH₄), and the produced oligosilane includes hexahydrodisilane (Si₂H).
<3> The method for producing an oligosilane according to <1>, wherein the method is for producing an oligosilane represented by the following formula (P-1), and in the first step, the oligosilane represented by formula (P-1) is produced from an oligosilane represented by the following formula (R-1) using the oligosilane represented by formula (R-1) as a raw material hydrosilane together with tetrahydrosilane (SiH₄):

SiₙH₂ₙ₊₂ (P-1)

where n represents an integer of from 2 to 5,

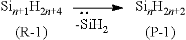

where n represents an integer of from 2 to 5.
<4> The method for producing an oligosilane according to <3>, wherein the oligosilane represented by formula (R-1) is octahydrotrisilane (Si₃H), and the oligosilane represented by formula (P-1) is hexahydrodisilane (Si₂H₆).
<5> The method for producing an oligosilane according to <1>, wherein the method is for producing an oligosilane represented by the following formula (P-2), and in the first step, the oligosilane represented by formula (P-2) is produced from an oligosilane represented by the following formula (R-2) using the oligosilane represented by formula (R-2) as a raw material hydrosilane together with tetrahydrosilane (SiH₄):

SiₘH₂ₘ₊₂ (P-2)

where m represents an integer of from 3 to 5,

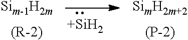

where m represents an integer of from 3 to 5.
<6> The method for producing an oligosilane according to <5>, wherein the oligosilane represented by formula (R-2) is hexahydrodisilane (Si₂H₆), and the oligosilane represented by formula (P-2) is octahydrotrisilane (Si₃H₈).
<7> The method for producing an oligosilane according to any one of <1> to <6>, wherein the membrane used in the treatment (A) has a pore diameter of at least 0.1 nm and not more than 100 μm.
<8> The method for producing an oligosilane according to any one of <1> to <6>, wherein the adsorbent used in the treatment (B) has a BET specific surface area of at least 10 m²/g and not more than 1,000 m²/g.
<9> The method for producing an oligosilane according to any one of <1> to <8>, wherein the first step is carried out in the presence of hydrogen gas.
<10> The method for producing an oligosilane according to any one of <1> to <9>, wherein the first step is carried out in the presence of a catalyst containing a transition element.
<11> The method for producing an oligosilane according to <10>, wherein the transition element contained in the catalyst is at least one transition element selected from the group consisting of group 4 transition elements, group 5 transition elements, group 6 transition elements, group 7 transition elements, group 8 transition elements, group 9 transition elements, group 10 transition elements, and group 11 transition elements.
<12> The method for producing an oligosilane according to <10> or <11>, wherein the catalyst is a heterogeneous catalyst containing a support.
<13> The method for producing an oligosilane according to <12>, wherein the support is at least one selected from the group consisting of silica, alumina, and zeolites.
<14> The method for producing an oligosilane according to <13>, wherein the zeolite has pores with a minor diameter of at least 0.41 nm and a major diameter of not more than 0.74 nm.
<15> The method for producing an oligosilane according to any one of <1> to <14>, wherein the method is a one-pass method where the first step is carried out only once.
<16> The method for producing an oligosilane according to <1> or <2>, wherein the method is a recycling method where at least part of unreacted tetrahydrosilane (SiH₄) is resupplied and reused as a raw material in the first step.
<17> The method for producing an oligosilane according to any one of <3> to <14>, wherein the method is a recycling method where at least part of unreacted tetrahydrosilane (SiH₄) is resupplied and reused as a raw material in the first step.
<18> The method for producing an oligosilane according to <17>, wherein the method is a recycling method where further at least part of the oligosilane represented by formula (R-1) or the oligosilane represented by formula (R-2) is resupplied and reused as a raw material in the first step.
<19> The method for producing an oligosilane according to <17> or <18>, further comprising a step of separating hydrogen gas using a hydrogen separating membrane from the high raw-material content fluid obtained through the second step.
<20> An apparatus for producing an oligosilane, comprising:

a reactor for performing a first step of producing an oligosilane by dehydrogenative coupling of a hydrosilane:

a gas-liquid separation unit for performing a second step of separating a reaction-produced mixture fluid obtained through the first step into a high raw-material content fluid and a high product content fluid; and

a refining apparatus for distilling a gas-liquid separated liquid, wherein

the apparatus satisfies the following conditions (AA) and/or (BB):

(AA) the gas-liquid separation unit has a membrane separator and is for supplying the reaction-produced mixture fluid to the membrane separator to obtain the high raw-material content fluid as a fluid having permeated through a membrane and obtain the high product content fluid as a fluid having not permeated through the membrane,

(aa-1) the membrane of the membrane separator is made of a zeolite, porous silica, alumina, or zirconia,

(aa-2) the apparatus comprises a pressure adjusting unit configured to adjust a pressure of the reaction-produced mixture fluid supplied to the membrane separator to at least 0.1 MPa and not more than 10 MPa. and

(aa-3) the apparatus comprises a temperature adjusting unit configured to adjust a temperature of the reaction-produced mixture fluid supplied to the membrane separator to at least −10° C. and less than 300° C.; and

(BB) the gas-liquid separation unit has an adsorbent and is for bringing the reaction-produced mixture fluid into contact with the adsorbent to obtain the high raw-material content fluid as a fluid having not been adsorbed to the adsorbent and obtain the high product content fluid as a fluid having been adsorbed to and subsequently desorbed from the adsorbent,

(bb-1) the adsorbent is made of a zeolite, alumina gel, silica gel, or activated carbon,

(bb-2) the apparatus comprises a pressure adjusting unit configured to adjust a pressure of the reaction-produced mixture fluid brought into contact with the adsorbent to at least 0.1 MPa and not more than 20 MPa. and

(bb-3) the apparatus comprises a temperature adjusting unit configured to adjust a temperature of the reaction-produced mixture fluid brought into contact with the adsorbent to at least −50° C. and not more than 200° C.

<21> The apparatus for producing an oligosilane according to <20>, further comprising a hydrogen separation unit configured to selectively separate hydrogen contained in a gas-liquid separated gas.

### Effect of the Invention

According to one aspect of the present invention, oligosilane production is carried out more efficiently. In addition, according to another aspect of the present invention, an apparatus with which oligosilane production is carried out more efficiently is provided.

### BRIEF DESCRIPTION OF DRAWINGS

FIG. 1 is a schematic diagram of a continuous reaction apparatus that can be used in the oligosilane production method that is one aspect of the present invention (continuous one-pass method).

FIG. 2 is a schematic diagram of another continuous reaction apparatus that can be used in the oligosilane production method that is one aspect of the present invention (continuous recycling method).

FIGS. 3(a), 3(b) and 3(c) are schematic diagrams of reactors that can be used in the oligosilane production method of the present invention (including FIG. 3(a): a batch tank reactor, FIG. 3(b): a continuous tank reactor (fluidized bed), FIG. 3(c): a continuous tubular reactor (fixed bed)).

FIG. 4 is a schematic diagram of the reaction apparatus that was used in the Examples.

### DESCRIPTION OF EMBODIMENTS

Although specific examples will be described in the description of the details of the oligosilane production method and apparatus of the present invention, the present invention is not limited to the following description and can be appropriately modified in the execution insofar as there is no departure from the essential features of the present invention. In addition, the present invention can be combined with any feature described by other embodiments as long as such a combination can be carried out.

### <Oligosilane Production Method>

The oligosilane production method that is one aspect of the present invention (hereinafter may be abbreviated as “production method of the present invention”) includes a first step (hereinafter may be abbreviated as “Step 1”) of producing an oligosilane by dehydrogenative coupling of a hydrosilane: and a second step (hereinafter may be abbreviated as “Step 2”) of separating a reaction-produced mixture fluid obtained through Step 1 into a high raw-material content fluid and a high product content fluid by subjecting the reaction-produced mixture fluid to treatments (A) and/or (B) described below, and is characterized in that the molar concentration of an oligosilane with at least 2 and not more than 5 silicon atoms with respect to all silane compounds in the high raw-material content fluid is lower than the molar concentration of the oligosilane with at least 2 and not more than 5 silicon atoms with respect to all silane compounds in the reaction-produced mixture fluid and that the molar concentration of the oligosilane with at least 2 and not more than 5 silicon atoms with respect to all silane compounds in the high product content fluid is higher than the molar concentration of the oligosilane with at least 2 and not more than 5 silicon atoms with respect to all silane compounds in the reaction-produced mixture fluid. The concentrations of silane compounds in a gas are herein measured with a gas chromatograph mass spectrometer.

(A) When using a separation membrane

Supplying the reaction-produced mixture fluid to a membrane separator under conditions satisfying the following (a-1) to (a-3) to obtain the high raw-material content fluid as a fluid having permeated through a membrane and obtain the high product content fluid as a fluid having not permeated through the membrane:

(a-1) the membrane of the membrane separator is made of any material selected from a zeolite, porous silica, alumina, and zirconia;

(a-2) the reaction-produced mixture fluid supplied to the membrane separator has a pressure of at least 0.1 MPa and not more than 10 MPa: and

(a-3) the reaction-produced mixture fluid supplied to the membrane separator has a temperature of at least −10° C. and less than 300° C.

In membrane separation, a separation membrane is pressurized on the supplied gas side while the permeated gas side is at a lower pressure, whereby separation is performed. In such separation, there are methods such as vapor permeation in which each component is separated using the difference in permeation rate due to differences between a pore diameter of a membrane and the sizes of molecules, and pervaporation in which a component in a supplied gas or liquid is caused to permeate and evaporate through a homogeneous membrane without a pore using the difference in affinity with the membrane, whereby a condensed liquid is obtained as permeated vapor. In the former, the membrane has pores and is of a zeolite, porous silica or the like, while as for the latter, a polymer separation membrane and the like are known, and it is preferable to employ vapor permeation for separating the reaction-produced mixture fluid of the present invention.

Ordinarily, a separation membrane is used in the form of a plurality of cylinders so as to increase the permeation area of the separation membrane.

(B) When using an adsorbent

Bringing the reaction-produced mixture fluid into contact with an adsorbent under conditions satisfying the following (b-1) to (b-3) to obtain the high raw-material content fluid as a fluid having not been adsorbed to the adsorbent, while obtaining the high product content fluid by desorbing the high product content fluid adsorbed to the adsorbent, by depressurization or heating:

(b-1) the adsorbent is made of a zeolite, porous silica, alumina, or zirconia

(b-2) the mixture fluid brought into contact with the adsorbent has a pressure of at least 0.1 MPa and not more than 20 MPa; and

(b-3) the mixture fluid brought into contact with the adsorbent has a temperature of at least −50° C. and not more than 200° C.

When an adsorbent is used for separation, condensation in pores (capillary condensation), namely, condensation starting in a pore at a pressure lower than the normal conditions outside the pore, is used. An adsorption tower is filled with an adsorbent with micro- and mesopores which has a large specific surface area, and a high product content fluid to be separated is brought into contact with the adsorbent under pressure, whereby components with low vapor pressures are preferentially adsorbed. Subsequently, the adsorbed components are desorbed by depressurization, heating or the like and recovered.

The treatment itself may be a batch treatment or a continuous treatment. In this case, a continuous treatment means that the treatment is continuously performed by providing and switching between a plurality of adsorption towers.

The present inventors found out that oligosilane production can be carried out more efficiently by supplying a reaction-produced mixture fluid which contains an oligosilane obtained by the dehydrogenative coupling of a hydrosilane to a membrane separator under the above-described conditions and/or by bringing the reaction-produced mixture fluid into contact with an adsorbent under the above-described conditions. That is, the present inventors found out that an oligosilane in a reaction produced mixture can be efficiently refined by condensation, and oligosilane production can be more efficiently carried out. The present inventors also found out that reuse of unreacted tetrahydrosilane and the like is facilitated, and oligosilane production can be carried out further efficiently as a whole.

“Hydrosilane” herein refers to a silane compound (the number of silicon atoms may be one or more) in which every bond of a silicon atom is joined to a hydrogen atom (Si—H bond) or joined to a silicon atom (Si—Si bond). “Monosilane” herein refers to tetrahydrosilane, “disilane” herein refers to hexahydrodisilane, “trisilane” herein refers to octahydrotrisilane, and “oligosilane” herein refers to a silane oligomer provided by the coupling of two to five individual (mono)silane molecules. “All silane compounds” herein refers to all silane compounds contained in a raw material and a product and includes tetrahydrosilane, hexahydrodisilane, octahydrotrisilane, and oligosilane. “Dehydrogenative coupling” of a hydrosilane herein refers to a reaction in which the silicon-silicon (Si—Si) bond is formed by hydrosilane-to-hydrosilane coupling with the elimination of a hydrogen molecule (H₂), as represented by the following reaction formula (1). Specific examples include a reaction in which the silicon-silicon (Si—Si) bond is formed by hydrosilane-to-hydrosilane, oligosilane-to-oligosilane, or tetrahydrosilane-to-oligosilane coupling with the elimination of a hydrogen molecule (H₂).

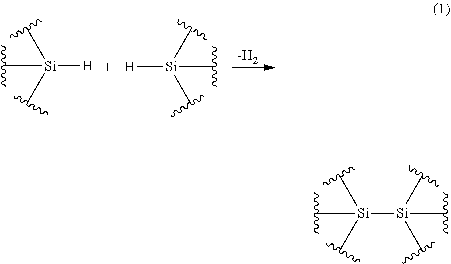

For example, when tetrahydrosilane is a raw material, the reaction is represented by the following reaction formula (2).

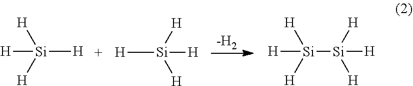

The production method of the present invention should include Steps 1 and 2, but the specific aspects of the entire “oligosilane production method” until isolating an oligosilane are not particularly limited and may be classified as either (i) or (ii) below ((ii) may be classified into (ii-1) and (ii-2)).

(i) Batch method: a method in which introduction of a hydrosilane into a reactor, a reaction, and recovery of a reacted mixture fluid in Step 1 and execution of Step 2 are carried out independently from each other.
(ii) Continuous method: a method in which introduction of a hydrosilane into a reactor, a reaction, and recovery of a reacted mixture fluid in Step 1 and execution of Step 2 are continuously carried out.

(ii-1) One-pass method: a method in which reuse of a hydrosilane and the like recovered in Step 2 is carried out as a separate step and not continuously performed, unlike in (ii-2).

(ii-2) Recycling method: a method in which Step 1 is carried out continuously in such a manner that all or part of a hydrosilane and oligosilanes and the like usable for a reaction recovered in Step 2 is reintroduced into a reactor without isolation of the remaining reaction gas and in a gaseous as-is state.

“Step 1”, “Step 2”, and the like are described in detail in the following.

### (Step 1)

Step 1 includes producing an oligosilane by dehydrogenative coupling of a hydrosilane.

Hydrosilanes are compounds in which every bond of a silicon atom is joined to a hydrogen atom (Si—H bond) or joined to a silicon atom (Si—Si bond). Specific examples include tetrahydrosilane (SiH₄), hexahydrodisilane (Si₂H₆), and octahydrotrisilane (Si₃H₈). The hydrosilane as a raw material may be selected depending on a desired oligosilane to be produced.

As described above, “oligosilane” is a silane oligomer provided by the coupling of a plurality of (two to five) individual (mono)silane molecules. The number of silicon atoms of the oligosilane is preferably from 2 to 4, more preferably from 2 to 3, and still more preferably 2.

Examples of the oligosilane include hexahydrodisilane (Si₂H₆), octahydrotrisilane (Si₃H₈), and decahydrotetrasilane (Si₄H₁₀).

In Step 1, when a silane compound with n silicon atoms is introduced as a raw material and reacted, a silane compound with (n+1) silicon atoms is provided as a main product. This is considered to be caused by that in the reaction producing an oligosilane from a hydrosilane, which is a seemingly dehydrogenative reaction, silylene is produced as follows: monosilane (tetrahydrosilane) yields silylene and hydrogen when monosilane (tetrahydrosilane) is a raw material, or disilane (hexahydrodisilane) yields silylene and monosilane (tetrahydrosilane) when disilane (hexahydrodisilane) is a raw material, and the produced silylene reacts with silanes and grows (silylene reacts with monosilane (tetrahydrosilane) to produce disilane (hexahydrodisilane) when monosilane (tetrahydrosilane) is used as a raw material, or silylene reacts with disilane (hexahydrodisilane) to produce trisilane (octahydrotrisilane) when disilane (hexahydrodisilane) is used as a raw material). It is noted that as described above, the reaction in a system using disilane (hexahydrodisilane) starts from the decomposition into monosilane (tetrahydrosilane) and silylene, and hence the reaction product necessarily contains monosilane (tetrahydrosilane). A case where monosilane (tetrahydrosilane), which is with one silicon atom, is used as a raw material will be described below in detail as an example.

When tetrahydrosilane (SiH₄), which is with one silicon atom, is used as a raw material, hexahydrodisilane (Si₂H₆) can be produced as in the following formula.

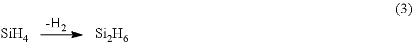

In this case, an oligosilane, in which the number of silicon atoms is not one, may be used as a raw material in combination with tetrahydrosilane. When using an oligosilane in combination, specifically, Step 1 is preferably the following Step 1-1 or 1-2.

Step 1-1 includes producing an oligosilane represented by the following formula (P-1) from an oligosilane represented by the following formula (R-1) using the oligosilane represented by formula (R-1) as a raw material:

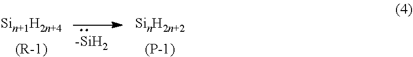

where n represents an integer of from 2 to 5.

The silylene (:SiH₂) produced in this reaction formula can react with tetrahydrosilane to turn into hexahydrodisilane (refer to formula (7)).

Step 1-2 includes producing an oligosilane represented by formula (P-2) from an oligosilane represented by the following formula (R-2) using the oligosilane represented by formula (R-2) as a raw material:

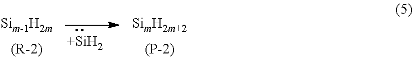

where m represents an integer of from 3 to 5.

The above silylene (:SiH₂) is produced together with hydrogen as a result of the decomposition of tetrahydrosilane (refer to formula (9)).

When including Step 1-1 as Step 1, the method is for producing the oligosilane represented by formula (P-1):

SiₙH₂ₙ₊₂ (P-1)

where n represents an integer of from 2 to 5.

On the other hand, when including Step 1-2 as Step 1, the method is for producing the oligosilane represented by formula (P-2):

SiₘH₂ₘ₊₂ (P-2)

where m represents an integer of from 3 to 5.

When Step 1 includes Step 1-1 or 1-2 in addition to a step of producing disilane from monosilane, selectivity for disilane as a target is improved, and disilane can be more efficiently produced.

For example, as represented by the following formula (6), trisilane is known to decompose into silylene (:SiH₂) and disilane by thermal decomposition, and silylene can react with monosilane to convert to disilane in the presence of excess monosilane (refer to formula (7)). In other words, one molecule of trisilane can be converted to two molecules of disilane with the addition of monosilane as a raw material, and as a result, selectivity for disilane in the reaction can be improved.

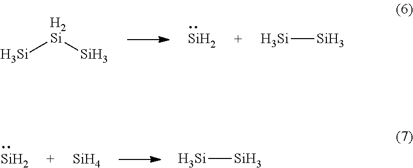

Further, for example, in continuous production of disilane, by recovering trisilane produced as a by-product and supplying the recovered trisilane as a raw material together with monosilane, an improved selectivity for disilane and reuse of trisilane are achieved. Thus, a very efficient production method is provided.

Still further, it is also possible to run a reaction producing disilane from tetrahydrosilane and recover disilane produced during the reaction to use the recovered disilane as a raw material together with monosilane to thereby produce trisilane. Disilane is also known to decompose into silylene (:SiH₂) and monosilane (refer to formula (8)), and when a large amount of disilane is present, silylene produced from monosilane (refer to formula (9)) and silylene produced from disilane (refer to formula (8)) react with disilane to produce trisilane (refer to formula (10): therefore, selectivity for trisilane can be relatively increased.

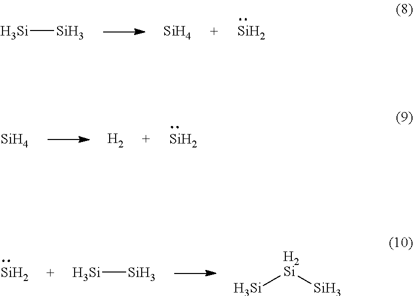

“Step 1-1”, “Step 1-2”, and the like are described in detail in the following.

Step 1-1 is characterized in using the oligosilane represented by formula (R-1) as a raw material, and when disilane (Si₂H₆) is a target oligosilane, octahydrotrisilane (Si₃Ha) is used as the oligosilane represented by formula (R-1) together with tetrahydrosilane (SiH₄).

In Step 1-1, the amount of an the oligosilane represented by formula (R-1) used is preferably at least 0.001 times the amount of tetrahydrosilane used on molar basis, more preferably at least 0.005 times, and still more preferably at least 0.01 times and is preferably not more than 0.5 times, more preferably not more than 0.3 times, and still more preferably not more than 0.2 times. When the amount of the oligosilane represented by formula (R-1) used is at least 0.001 times the amount of tetrahydrosilane used, it has an effect of increasing the selectivity for a target oligosilane, while when not more than 0.5 times, the by-production of an oligosilane with a larger number of silicon atoms than a target oligosilane, which is caused by a reaction of silylene generated from the oligosilane and monosilane with the oligosilane, can be suppressed to a low level that causes no problem.

Step 1-2 is characterized in using the oligosilane represented by formula (R-2) as a raw material, and for example, when octahydrotrisilane (Si₃H) is a target oligosilane, hexahydrodisilane (Si₂H₆) is used as the oligosilane represented by formula (R-2) together with tetrahydrosilane (SiH₄).

In Step 1-2, the amount of the oligosilane represented by formula (R-2) used is preferably at least 0.1 times the amount of tetrahydrosilane (SiH₄) used on molar basis, more preferably at least 0.15 times, and still more preferably at least 0.2 times and is preferably not more than 2 times, more preferably not more than 1.5 times, and still more preferably not more than 1 times. Here, when the amount of the oligosilane represented by formula (R-2) used is at least 0.1 times the amount of tetrahydrosilane (SiH₄) used, increased efficiency in the reaction between generated silylene and the oligosilane is achieved, which has an effect of increasing the number of silicon atoms. In addition, when it is not more than 2 times, the by-production of an oligosilane with a larger number of silicon atoms than a target oligosilane, which is caused by a reaction of silylene generated from the oligosilane and monosilane with the oligosilane, can be suppressed to a low level that causes no problem.

When in the absence of a catalyst, the reaction temperature in Step 1 (including the cases of Steps 1-1 and 1-2) is preferably at least 300° C. and not more than 550° C., and more preferably at least 400° C. and not more than 500° C., depending on the operation pressure and the reaction time. When a catalyst is used, the reaction temperature is preferably at least 50° C., more preferably at least 100° C. and is preferably not more than 400° C., more preferably not more than 350° C., and still more preferably not more than 300° C., depending on the operation pressure. If within the indicated ranges, oligosilane production can be carried out more efficiently. In any case, it is preferable to suppress the conversion of monosilane and oligosilanes used as raw materials to not more than 30% and more preferably not more than 20% by adjusting the reaction time (the residence time of the raw materials in the reactor in the absence of a catalyst, or when a catalyst is used, the contact time of the raw materials with the catalyst). It is possible but not preferable to make the conversion higher than 30%, because a higher conversion results in sequential production of a polysilane with a higher molecular weight, and if the conversion is made too high, a solid polysilane could be produced. The reaction time is from 1 second to 1 hour, more preferably from 5 seconds to 30 minutes, and even more preferably from 10 seconds to 10 minutes, depending on the reaction temperature and the presence or absence of a catalyst.

Step 1 (including the cases of Steps 1-1 and 1-2) are preferably carried out in the presence of a catalyst that contains a transition element (hereinafter may be abbreviated as “transition element-containing catalyst”) from the stand point of efficiency of oligosilane production. The specific species of the transition element is not particularly limited, and examples thereof include group 3 transition elements, group 4 transition elements, group 5 transition elements, group 6 transition elements, group 7 transition elements, group 8 transition elements, group 9 transition elements, group 10 transition elements, and group 11 transition elements.

Examples of group 3 transition elements in the transition element-containing catalyst include scandium (Sc), yttrium (Y), lanthanoid (La), and samarium (Sm).

Examples of group 4 transition elements include titanium (Ti), zirconium (Zr), and hafnium (Hf).

Examples of group 5 transition elements include vanadium (V), niobium (Nb), and tantalum (Ta).

Examples of group 6 transition elements include chromium (Cr), molybdenum (Mo), and tungsten (W).

Examples of group 7 transition elements include manganese (Mn), technetium (Tc), and rhenium (Re).

Examples of group 8 transition elements include iron (Fe), ruthenium (Ru), and osmium (Os).

Examples of group 9 transition elements include cobalt (Co), rhodium (Rh), and iridium (Ir).

Examples of group 10 transition elements include nickel (Ni), palladium (Pd), and platinum (Pt).

Examples of group 11 transition elements include copper (Cu), silver (Ag), and gold (Au).

Among these transition elements, group 4 transition elements, group 5 transition elements, group 6 transition elements, group 7 transition elements, group 8 transition elements, group 9 transition elements, group 10 transition elements, and group 11 transition elements are preferred, among which tungsten (W), vanadium (V), molybdenum (Mo), cobalt (Co), nickel (Ni), palladium (Pd), and platinum (Pt) are more preferred, and tungsten (W), and molybdenum (Mo) are even more preferred.

As long as the transition element-containing catalyst contains a transition element, it may be a heterogeneous catalyst or a homogeneous catalyst; however, heterogeneous catalysts are preferred. The catalyst is particularly preferably a support-containing heterogeneous catalyst that contains the transition element on the surface and/or in the interior of the support.

The form and composition of the transition element in the transition element-containing catalyst are also not particularly limited, and, for example, in the case of a heterogeneous catalyst, the form may be that of a metal (including a metal simple substance, an alloy, and a metal whose surface is partially oxidized) or may be that of a metal oxide (a single metal oxide, a composite metal oxide). When the catalyst is a support-containing heterogeneous catalyst, for example, the metal and/or metal oxide of the transition element may be supported at the surface of the support (outer surface and/or within the pores) or the transition element may be introduced into the interior of the support (support framework) by ion exchange or composite formation.

On the other hand, examples of the homogeneous catalyst include organometal complexes in which the central metal is a transition element.

Examples of the metal (whose surface could be partially oxidized) include scandium, yttrium, lanthanoid, samarium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, gold, and their alloys.

Examples of the metal oxide include scandium oxide, yttrium oxide, lanthanoid oxide, samarium oxide, titanium oxide, zirconium oxide, hafnium oxide, vanadium oxide, niobium oxide, tantalum oxide, chromium oxide, molybdenum oxide, tungsten oxide, manganese oxide, technetium oxide, rhenium oxide, iron oxide, ruthenium oxide, osmium oxide, cobalt oxide, rhodium oxide, iridium oxide, nickel oxide, palladium oxide, platinum oxide, copper oxide, silver oxide, and their composite oxides.

While the specific species of the support when the catalyst in the transition element-containing catalyst is a support-containing heterogeneous catalyst is not particularly limited, examples thereof include silica, alumina, titania, zirconia, silica-alumina, zeolites, activated carbon, and aluminum phosphate, and the support is preferably any one of silica, alumina, titania, zirconia, a zeolite, and activated carbon. Among these, supporting the transition element on silica, alumina, or a zeolite is preferred from the standpoint of the thermal stability, while zeolites are more preferred from the standpoint of the disilane selectivity, a zeolite having pores with a minor diameter of at least 0.41 nm and a major diameter of not more than 0.74 nm is still more preferred, and a zeolite having pores with a minor diameter of at least 0.43 nm and a major diameter of not more than 0.69 nm is particularly preferred. The pore space in the zeolite is considered to act as a reaction field for dehydrogenative coupling, and a pore size of “a minor diameter of at least 0.41 nm and a major diameter of not more than 0.74 nm” is considered to be suitable for suppressing excessive polymerization and bringing about an improved selectivity for an oligosilane.

It is noted that “a zeolite having pores with a minor diameter of at least 0.41 nm and a major diameter of not more than 0.74 nm” does not mean only zeolites that actually have “pores with a minor diameter of at least 0.41 nm and a major diameter of not more than 0.74 nm”, but also includes zeolites for which the pore “minor diameter” and “major diameter” as theoretically calculated from the crystalline structure respectively satisfy the aforementioned conditions. For the pore “minor diameter” and “major diameter”, reference can be made to “ATLAS OF ZEOLITE FRAMEWORK TYPES, Ch. Baerlocher, L. B. McCusker and D. H. Olson, Sixth Revised Edition 2007, published on behalf of the Structure Commission of the International Zeolite Association”.

The minor diameter for the zeolite is preferably at least 0.43 nm, more preferably at least 0.45 nm, and is still more preferably at least 0.47 nm.

The major diameter for the zeolite is preferably not more than 0.69 nm, more preferably not more than 0.65 nm, and still more preferably not more than 0.60 nm.

When the pore diameter of the zeolite is constant because, for example, the cross-sectional structure of the pore is circular, the pore diameter is then regarded as “at least 0.41 nm and not more than 0.74 nm”.

When the zeolite has a plurality of pore diameters, then the pore diameter of at least one type of pore should be “at least 0.41 nm and not more than 0.74 nm”.

The specific zeolite is preferably a zeolite having a framework type code as provided in the database of the International Zeolite Association corresponding to the following: AFR, AFY, ATO, BEA, BOG, BPH, CAN, CON, DFO, EON, EZT. FAU, FER, GON. IMF, ISV, ITH, IWR, IWV, IWW, LTA, LTL, MEI, MEL, MFI, MOR, MWW, OBW, MOZ, MSE, MTT, MTW, NES, OFF, OSI, PON, SFF, SFG, STI, STF, TER, TON, TUN, USI, and VET.

Zeolites with framework type codes corresponding to the following are more preferred: ATO, BEA, BOG, CAN, IMF, ITH, IWR, IWW, MEL, MFI, OBW, MSE, MTW, NES, OSI, PON, SFF, SFG, STF, STI, TER, TON, TUN, and VET.

Zeolites with framework type codes corresponding to BEA, MFI, and TON are particularly preferred.

Examples of zeolites with a framework type code corresponding to BEA include *Beta (beta), [B—Si—O]-*BEA, [Ga—Si—O]-*BEA. [Ti—Si—O]-*BEA, Al-rich beta. CIT-6, Tschernichite, and pure silica beta (the * indicates a mixed crystal of three polytypes with similar structures).

Examples of zeolites with a framework type code corresponding to MFI include *ZSM-5, [As—Si—O]-MFI, [Fe—Si—O]-MFI, [Ga—Si—O]-MFI, AMS-1B, AZ-1, Bor-C, Boralite C, Encilite, FZ-1, LZ-105, Monoclinic H-ZSM-5, Mutinaite, NU-4, NU-5, Silicalite, TS-1, TSZ, TSZ-III, TZ-01, USC-4, USI-108, ZBH, ZKQ-1B, ZMQ-TB, and organic-free ZSM-5 (the * indicates a mixed crystal of three polytypes with similar structures).

Examples of zeolites with a framework type code corresponding to TON include Theta-1, ISI-1, KZ-2, NU-10, and ZSM-22.

Zeolites ZSM-5, beta, and ZSM-22 are particularly preferred.

The silica/alumina ratio (mol/mol ratio) is preferably from 5 to 10,000, more preferably from 10 to 2,000, and particularly preferably from 20 to 1,000.

When the transition element-containing catalyst is a heterogeneous catalyst, the transition element content (overall content) in the catalyst with respect to the total mass of the entire catalyst (when the catalyst contains a support, the mass of the support is also included) is preferably at least 0.01 mass %, more preferably at least 0.1 mass %, and still more preferably at least 0.5 mass % and is preferably not more than 50 mass %, more preferably not more than 20 mass %, and still more preferably not more than 10 mass %. If within the indicated ranges, a good reaction conversion can be secured, and side reactions due to excessive use can be suppressed. As a consequence, oligosilane production can be carried out more efficiently.

When the transition element-containing catalyst is a support-containing heterogeneous catalyst, the catalyst preferably has the form of a molding provided by molding a powder into, for example, a spherical shape, cylindrical shape (pellet shape), ring shape, or honeycomb shape. A binder such as alumina and a clay compound, may be used in order to mold the powder. The strength of the molding cannot be maintained when the amount of binder use is too small; when the amount of binder use is too large, this has a negative effect on the catalytic activity. Thus, when alumina is used as the binder, the alumina content (per 100 mass parts of the support not containing the alumina) is preferably at least 2 mass parts, more preferably at least 5 mass parts, and still more preferably at least 10 mass parts and is preferably not more than 50 mass parts, more preferably not more than 40 mass parts, and still more preferably not more than 30 mass parts. If within the indicated ranges, negative effects on the catalytic activity can be suppressed while the strength of the support is maintained.

Examples of the methods of loading the support with the transition element include impregnation and ion-exchange, which use a precursor in solution form, and a method in which a precursor is volatilized by, for example, sublimation, and vapor deposited on the support. Impregnation is a method in which the support is brought into contact with a solution in which a transition element compound is dissolved and the transition element compound is thereby adsorbed to the surface of the support. Pure water is ordinarily used for the solvent, but organic solvents such as methanol, ethanol, acetic acid, and dimethylformamide, may also be used as long as they dissolve the transition element compound. Ion-exchange is a method in which a support having acid sites, e.g., a zeolite, is brought into contact with a solution in which an ion of the transition element is dissolved, thereby introducing the transition element ion at the acid sites on the support. Pure water is again ordinarily used as the solvent in this case, but organic solvents such as methanol, ethanol, acetic acid, and dimethylformamide, may also be used as long as they dissolve the transition element. Vapor deposition is a method in which the transition element itself or the transition element oxide is heated in order to volatilize the same by, e.g., sublimation, and thereby bring about its vapor deposition on the support. After the execution of impregnation, ion-exchange, vapor deposition, or the like, preparation of the metal or metal oxide form desired for the catalyst can be carried out by the execution of treatments such as drying, and firing in a reducing atmosphere or an oxidizing atmosphere.

Examples of the precursor for the transition element-containing catalyst include the following in the case of molybdenum: ammonium heptamolybdate, silicomolybdic acid, phosphomolybdic acid, molybdenum chloride, and molybdenum oxide. In the case of tungsten, the examples include ammonium paratungstate, phosphotungstic acid, silicotungstic acid, and tungsten chloride. In the case of vanadium, the examples include vanadium oxysulfate, vanadium chloride, and ammonium metavanadate. In the case of cobalt, the examples include cobalt nitrate and cobalt chloride. In the case of nickel, the examples include nickel nitrate and nickel chloride. In the case of palladium, the examples include palladium nitrate and palladium chloride. In the case of platinum, the examples include a nitric acid solution of diammine dinitro platinum (II) and tetraammine platinum (II) chloride.

When the transition element-containing catalyst is a heterogeneous catalyst, the catalyst preferably contains at least one main group element (hereinafter may be abbreviated as “main group element”) selected from the group consisting of Periodic Table group 1 main group elements and group 2 main group elements. The form and composition of the main group element in the catalyst is not particularly limited, and examples of the form include a metal oxide (single metal oxide, composite metal oxide) and an ion. In addition, when the transition element-containing catalyst is a support-containing heterogeneous catalyst, for example, the main group element may be supported in the form of the metal oxide or metal salt at the surface of the support (outer surface and/or within the pores) or the main group element may be introduced into the interior (support framework) by ion exchange or composite formation. The incorporation of such a main group element restrains the initial silane conversion to inhibit excessive consumption, and in combination with this can raise the initial disilane selectivity. In addition, the catalyst life can also be extended by restraining the initial silane conversion.

Examples of group 1 main group elements include lithium (Li), sodium (Na), potassium (K), rubidium (Rb), cesium (Cs), and francium (Fr).

Examples of group 2 main group elements include beryllium (Be), magnesium (Mg), calcium (Ca), strontium (Sr), barium (Ba), and radium (Ra).

Among the preceding, the incorporation of sodium (Na), potassium (K), rubidium (Rb), cesium (Cs), francium (Fr), calcium (Ca), strontium (Sr), and barium (Ba) is preferred.

When the transition element-containing catalyst is a support-containing heterogeneous catalyst, impregnation and ion-exchange are examples of methods for incorporating the main group element into the catalyst. Impregnation is a method in which the support is brought into contact with a solution in which a main group element-containing compound is dissolved and the main group element is thereby adsorbed to the surface of the support. Pure water is ordinarily used for the solvent, but organic solvents, e.g., methanol, ethanol, acetic acid, and dimethylformamide, can also be used as long as they dissolve the main group element-containing compound. Ion-exchange is a method in which a support having acid sites, e.g., a zeolite, is brought into contact with a solution provided by dissolving a compound from which the main group element can dissociate as an ion upon dissolution, to thereby introduce the main group element ion at the acid sites on the support. Pure water is also ordinarily used as the solvent in this case, but organic solvents such as methanol, ethanol, acetic acid, and dimethylformamide, may also be used as long as they dissolve the main group element ion. Treatments such as drying and firing may be carried out after the execution of impregnation or ion-exchange.

In the case of the incorporation of lithium (Li), examples of the solution include an aqueous lithium nitrate (LiNO₃) solution, an aqueous lithium chloride (LiCI) solution, an aqueous lithium sulfate (Li₂SO₄) solution, an acetic acid solution of lithium acetate (LiOCOCH₃), and an ethanol solution of lithium acetate.

In the case of the incorporation of sodium (Na), examples of the solution include an aqueous sodium chloride (NaCl) solution, an aqueous sodium sulfate (Na₂SO₄) solution, and an aqueous sodium nitrate (NaNO₃).

In the case of the incorporation of potassium (K), examples of the solution include an aqueous potassium nitrate (KNO₃) solution, an aqueous potassium chloride (KCl) solution, an aqueous potassium sulfate (K₂SO₄) solution, an acetic acid solution of potassium acetate (KOCOCH.), and an ethanol solution of potassium acetate.

In the case of the incorporation of rubidium (Rb), examples of the solution include an aqueous rubidium chloride (RbCl) solution and an aqueous rubidium nitrate (RbNO₃) solution.

In the case of the incorporation of cesium (Cs), examples of the solution include an aqueous cesium chloride (CsCl), an aqueous cesium nitrate (CsNO₃) solution, and an aqueous cesium sulfate (Cs₂SO₄) solution.

In the case of the incorporation of francium (Fr), examples of the solution include an aqueous francium chloride (FrCl) solution.

In the case of the incorporation of calcium (Ca), examples of the solution include an aqueous calcium chloride (CaCl₂)) solution and an aqueous calcium nitrate (Ca(NO₃)₂) solution.

In the case of the incorporation of strontium (Sr), examples of the solution include an aqueous strontium nitrate (Sr(NO₃)₂) solution.

In the case of the incorporation of barium (Ba), examples of the solution include an aqueous barium chloride (BaCl₂) solution and an aqueous barium nitrate (Ba(NO₃)₂) solution.

When the transition element-containing catalyst is a support-containing heterogeneous catalyst, the overall content of the main group element in the catalyst (with respect to the mass of the support in a state containing the transition element, main group element, and so forth) is preferably at least 0.01 mass %, more preferably at least 0.05 mass %, still more preferably at least 0.1 mass %, particularly preferably at least 0.5 mass %, more particularly preferably at least 1.0 mass %, and most preferably at least 2.1 mass % and is preferably not more than 10 mass %, more preferably not more than 5 mass %, and still more preferably not more than 4 mass %. If within the indicated ranges, oligosilane production can be carried out more efficiently.

The reactor, operating procedure, reaction conditions, and the like used in Step 1 (including the cases of Steps 1-1 and 1-2) are not particularly limited and can be selected as appropriate according to the purpose. The reactor, operating procedure, and the like are described below with specific examples, but not limited to the examples described.

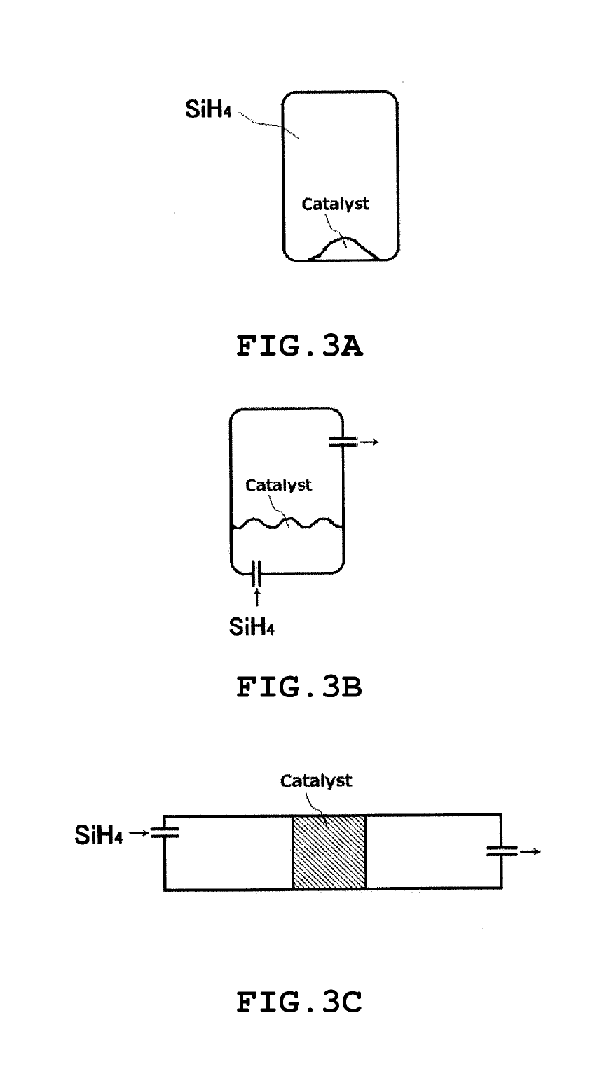

The reactor used in a batch method is exemplified by a tank reactor as shown in FIG. 3(a), and the reactor used in a continuous method is exemplified by a tank reactor (fluidized bed) as shown in FIG. 3(b) and a tubular reactor (fixed bed) as shown in FIG. 3(c).

The operating procedure in, for example, a batch method, is exemplified by the following method: the air in a reactor is removed using a vacuum pump or the like; subsequently, tetrahydrosilane and the like are introduced and sealing is performed; and the reaction is started by raising the interior of the reactor to the reaction temperature. When a catalyst is used, the operating procedure for example includes placing a dried catalyst in the reactor before removing the air in the reactor.

On the other hand, in a continuous method, the operating procedure is exemplified by the following method: the air in the reactor is removed using a vacuum pump or the like; subsequently, tetrahydrosilane and the like are caused to flow through: and the reaction is started by raising the interior of the reactor to the reaction temperature. When a catalyst is used, the operating procedure for example includes placing a dried catalyst in the reactor before removing the air in the reactor. The catalyst may be either a fixed-bed catalyst as shown in FIG. 3(c) or a fluidized bed catalyst as shown in FIG. 3(b), based on which an operation procedure may be employed as appropriate.

Compounds other than a hydrosilane and the like may be introduced into or passed through the reactor. Examples of the compounds other than a hydrosilane and the like include gases such as hydrogen gas, helium gas, nitrogen gas, and argon gas, and execution in the presence of hydrogen gas is particularly preferred. Since tetrahydrosilane is highly reactive, in a batch method and a continuous one-pass method, it is preferable to introduce an inert gas such as argon gas. In a continuous recycling method, when tetrahydrosilane and the like recovered in Step 2 are introduced into the reactor and used as they are, it is desirable not to include other gases since other gases are accumulated and condensed.

A preferred range of the reaction pressure in Step 1 (including the cases of Steps 1-1 and 1-2) varies depending on the reaction temperature, and the partial pressure of each component introduced into the reactor needs to be within the range where condensation at the reaction temperature does not occur. When a target oligosilane is disilane, the reaction pressure, considered as the absolute pressure, is preferably at least 0.1 MPa, more preferably at least 0.15 MPa. and still more preferably at least 0.2 MPa and is preferably not more than 10 MPa, more preferably not more than 5 MPa, and still more preferably not more than 3 MPa, depending on the reaction temperature. The tetrahydrosilane partial pressure is preferably at least 0.0001 MPa, more preferably at least 0.0005 MPa. and still more preferably at least 0.001 MPa and is preferably not more than 10 MPa, more preferably not more than 5 MPa. and still more preferably not more than 1 MPa. If within the indicated ranges, oligosilane production can be carried out more efficiently.

When a target oligosilane is trisilane, the reaction pressure, considered as the absolute pressure, is preferably at least 0.1 MPa, more preferably at least 0.125 MPa, and still more preferably at least 0.15 MPa and is preferably not more than 5 MPa, more preferably not more than 4 MPa. and still more preferably not more than 2 MPa. In this case, the disilane partial pressure is preferably at least 0.00005 MPa, more preferably at least 0.0001 MPa. and still more preferably at least 0.0002 MPa and is preferably not more than 3 MPa, more preferably not more than 1 MPa, and still more preferably not more than 0.8 MPa. If within the indicated ranges, oligosilane production can be carried out more efficiently.

In a batch method, with respect to the total volume of a fluid containing a raw material hydrosilane introduced into the reactor, the hydrosilane as a raw material is preferably at least 5 volume % and not more than 100 volume %, more preferably at least 10 volume % and not more than 90 volume %, and still more preferably at least 20 volume % and not more than 80 volume %. Since disilane tends to condense more easily than tetrahydrosilane, execution while adjusting the temperature and pressure so as not to cause condensation is preferred.

When Step 1 (including the cases of Steps 1-1 and 1-2) is carried out in the presence of hydrogen gas, the ratio of the partial pressure of the hydrogen gas with respect to the partial pressure of the hydrosilane and the oligosilane is within the range of preferably from 0.05 to 5 times, more preferably from 0.1 to 4 times, and still more preferably from 0.02 to 2 times (hydrogen gas pressure/(hydrosilane and oligosilane) pressure).

A hydrogen separation membrane (described in the fourth step to be described later) may be used to separate hydrogen gas from a reaction-produced mixture fluid which is obtained through Step 1 (including the cases of Steps 1-1 and 1-2) and cooled as needed.

### (Step 2)

Step 2 includes subjecting a reaction-produced mixture fluid (hereinafter may be abbreviated as “mixture fluid”) obtained through Step 1 to the above-described treatments (A) and/or (B) to thereby separate the mixture fluid into a high raw-material content fluid (hereinafter may be abbreviated as “high raw-material content fluid) in which the molar concentration of an oligosilane with at least 2 and not more than 5 silicon atoms with respect to all silane compounds is lower than the molar concentration of the oligosilane with at least 2 and not more than 5 silicon atoms with respect to all silane compounds in the reaction-produced mixture fluid, that is, the concentration of a raw material such as tetrahydrosilane is higher than that in the mixture fluid and into a high product content fluid (hereinafter may be abbreviated as “high product content fluid”) in which the molar concentration of the oligosilane with at least 2 and not more than 5 silicon atoms with respect to all silane compounds is higher than the molar concentration of the oligosilane with at least 2 and not more than 5 silicon atoms with respect to all silane compounds in the reaction-produced mixture fluid, that is, the concentration of a target oligosilane is higher than that in the mixture fluid. The treatments (A) and (B) will be described below in detail with an example where disilane is produced from monosilane.

The treatment (A) is supplying the mixture fluid to a membrane separator under conditions satisfying the above-described (a-1) to (a-3) to obtain the high raw-material content fluid as a fluid having permeated through a membrane and obtain the high product content fluid as a fluid having not permeated through the membrane. Since tetrahydrosilane, which is a relatively small molecule, permeates through the membrane preferentially over an oligosilane, the mixture fluid can be separated into the high raw-material content fluid and the high product content fluid by supplying the mixture fluid to a membrane separator.

The condition in (a-1), namely, the material of the membrane of the membrane separator may be selected so as to be able to separate silanes which are used as a raw material and are relatively small molecules and a target oligosilane.

In the case of a porous material, the pore diameter measured by a gas adsorption method or a mercury penetration method is preferably not more than 100 μm, more preferably not more than 50 μm, and still more preferably not more than 30 μm. Those having a regular pore diameter of not more than 2 nm, such as a zeolite, are more preferable. The lower limit of the pore diameter is generally at least 0.1 nm.

Specific examples of such materials include inorganic membranes such as zeolites, porous silica, alumina, and zirconia and organic membranes such as polyimide and a fluorine-based copolymer membrane, some of which are shaped into modules efficient for membrane separation and commercially available from device manufacturers. Among these, zeolites and porous silica are preferred from the standpoint of selectivity at the time of permeation, and zeolites are more preferred. A porous material having a pore diameter outside the above ranges may be included as long as the effects of the present invention are exerted.

As for the thickness of the membrane, generally, the thicker the membrane is, the better the separation performance is, but the slower the permeation rate tends to be. Thus, taking the surface area also into consideration, an optimal thickness of the membrane may be selected.

The condition in (a-2), namely, the pressure of the mixture fluid supplied to the membrane separator is preferably at least 0.1 MPa more preferably at least 0.15 MPa and still more preferably at least 0.2 MPa and is preferably not more than 10 MPa, more preferably not more than 5 MPa. and still more preferably not more than 1 MPa, varying depending on the temperature.

The condition in (a-3), namely the temperature of the mixture fluid supplied to the membrane separator is preferably at least −10° C. more preferably at least 10° C., and still more preferably at least 30° C. and is preferably less than 300° C. more preferably not more than 280° C., and still more preferably not more than 250° C.

If within the indicated ranges, oligosilane refining can be carried out more efficiently.

It is also possible to apply a nonporous membrane such as a polyimide membrane and a fluorine-based copolymer membrane.

The treatment (B) is bringing the mixture fluid into contact with an adsorbent under conditions satisfying the above-described (b-1) to (b-3) to separate the high raw-material content fluid as a fluid having not been adsorbed to the adsorbent. The treatment (B) is also obtaining the high product content fluid by adsorption to the adsorbent and subsequent desorption from the adsorbent. Since an oligosilane, which has a relatively large molecule weight, has a lower vapor pressure than that of tetrahydrosilane and tends to be selectively adsorbed to an adsorbent, the mixture fluid can be separated into the high raw-material content fluid and the high product content fluid by bringing the mixture fluid into contact with an adsorbent.

As for the condition in (b-1), namely, the adsorbent, those capable of adsorbing higher molecular weight substances more within the pores are desirable. Basically, a larger surface area is advantageous because a higher adsorption capacity is provided. The surface area as a BET specific surface area is preferably at least 10 m²/g and not more than 1,000 m²/g, more preferably at least 20 m²/g and not more than 800 m²/g, and still more preferably at least 30 m²/g and not more than 600 m²/g. An BET specific surface area is determined by measurement according to JIS Z 8830:2013 (ISO 9277:2010). In the Examples to be described later, nitrogen gas was used as a measurement (adsorption) gas, and a multipoint method was used for analyzing adsorption data. A smaller pore diameter is also preferable because condensation is easier to occur within the pores, and the pore diameter measured by a gas adsorption method or a mercury intrusion method is preferably not more than 100 μm, more preferably not more than 50 μm, and still more preferably not more than 30 μm. The lower limit of the pore diameter is at least 0.1 nm, preferably at least 0.2 nm, and still more preferably at least 0.3 nm. Such examples include zeolites (natural zeolites and synthetic zeolites (also called molecular sieve)), alumina gel, silica gel, and activated carbon, and one or more of these may be used. More preferred examples include a zeolite having pores (molecular sieve). Although an adsorbent may be used as it is in powder form, it is preferable from the standpoint of handling to use an adsorbent in the form of a molding provided by molding into, for example, a spherical shape, cylindrical shape (pellet shape), ring shape, or honeycomb shape. An adsorbent having a specific surface area and a pore diameter outside the above ranges may be included as long as the effects of the present invention are not inhibited.

The condition in (b-2), namely, the pressure of the mixture fluid brought into contact with the adsorbent is preferably at least 0.1 MPa, more preferably at least 0.15 MPa, and still more preferably at least 0.2 MPa and is preferably not more than 20 MPa, more preferably not more than 10 MPa, and still more preferably not more than 5 MPa.

The condition in (b-3), namely the temperature of the mixture fluid brought into contact with the adsorbent is preferably at least −50° C., more preferably at least −30° C., still more preferably at least 0° C. and particularly preferably at least 30° C. and is preferably not more than 200° C., more preferably not more than 180° C., and still more preferably not more than 150° C.

If within the indicated ranges, oligosilane refining can be carried out more efficiently.

Adsorbed molecules are desorbed by, for example, heating or depressurization, during which the heating temperature is generally at least 50° C. and not more than 300° C. and preferably at least 80° C. and not more than 200° C., while depressurization is carried out under a condition of preferably at a pressure of from 5% to 95% and more preferably at a pressure of from 10% to 90% with respect to the pressure for adsorption.

The treatment (B) may for example be carried out using an adsorption tower, and may use an adsorption tower with multiple adsorption beds.

Known materials and the like may be used for the separation membrane and adsorbent used in (A) and (B). By obtaining and using commercially available materials, Step 2 can be carried out inexpensively and easily, and a target oligosilane can be produced more efficiently and inexpensively.

If adsorption moisture is present on the materials for the separation membrane and adsorbent used in (A) and (B), the moisture reacts with silanes: therefore, it is essential to fully dry the materials in advance. In addition, since some separation membranes and adsorbents have, on their surfaces, functional groups such as silanol which are reactive with silanes, it is necessary to treat the material with tetrahydrosilane in advance so as to inactivate the surface against silanes.

A hydrogen separation membrane (described in the fourth step to be described later) may be used to separate hydrogen gas from the high raw-material content fluid obtained through Step 2.

### (Step 3)

The production method of the present invention may include a third step (hereinafter may be abbreviated as “Step 3”) in which the high product content fluid obtained through Step 2 is separated into liquid (a liquid phase) and gas (a gaseous phase).

From the high product content fluid, an oligosilane will be finally isolated through a refining step and the like to be described later, while in a recycling method, raw material components separated in the refining step, in some cases partially containing an oligosilane, will be reused in a gaseous state in Step 1 after going through Step 3 and the fourth step and the like to be described later.

Although the high product content fluid obtained through Step 2 is in some cases separated as it is into liquid (a liquid phase) and gas (a gaseous phase) in Step 3, generally, a cooling step is carried out before subjecting the high product content fluid to Step 3 so as to separate fluid and gas.

The cooling temperature in the cooling step prior to the Step 3 may be selected depending on a target oligosilane, and the cooling temperature when under normal pressure is generally at least −100° C. and not more than 50° C. and preferably at least −50° C. and not more than 30° C. when disilane is to be produced and is generally at least −50° C. and not more than 95° C. and preferably at least −30° C. and not more than 80° C. when trisilane is to be produced. Pressurization may be performed to carry out the operation at a higher operation temperature.

Step 3 may for example be carried out using an ordinary vaporizer, an apparatus employing gravitational separation, an apparatus employing surface tension separation, or an apparatus employing centrifugal separation, and may include heating so as to more efficiently recover the raw material.

In a recycling method, tetrahydrosilane dissolved in the liquid phase (liquid containing the high product content fluid) is preferably recovered in a gaseous state and reused together with the high raw-material content fluid.

The heating temperature is generally at least 50° C. and not more than 300° C. and preferably at least 80° C. and not more than 200° C.

### (Step 4)

When the production method of the present invention is a recycling method, the production method may further include a fourth step (hereinafter may be abbreviated as “Step 4”) which includes separating hydrogen gas from a mixture provided by combining the high raw-material content fluid obtained in Step 2 and the gas (gaseous phase) obtained through Step 3, using a hydrogen separation membrane.

In a recycling method, hydrogen gas by-produced by the reaction is accumulated. Thus, by inclusion of Step 4, hydrogen gas can be appropriately removed.

A hydrogen separation membrane is a semipermeable membrane which selectively allows hydrogen gas to permeate therethrough. The semipermeable membrane for example includes a compact layer which selectively allows hydrogen gas to permeate therethrough and a porous base material which supports the compact layer. Examples of the shape of the semipermeable membrane include a flat membrane, a spiral membrane, and a hollow fiber membrane, among which a hollow fiber membrane is more preferable. Examples of materials used for the compact layer include polyimide, polysiloxane, polysilazane, polyester, polycarbonate, cellulose polymer, polysulfone, polyalkylene glycol, polyethylene, polybutadiene, polystyrene, polyacrylonitrile, polyvinyl halide, polyvinylidene halide, and a block copolymer having a plurality of kinds of repeating units which can be polymerized by the same polymerization system among these polymers.

Other than those using these polymeric materials, those using a publicly known material such as carbon materials and palladium having hydrogen permeability may be used.

The conditions for Step 4 are as follows. The temperature is preferably at least 0° C. and not more than 300° C., more preferably at least 30° C. and not more than 250° C., and still more preferably at least 50° C. and not more than 200° C. The pressure, considered as the absolute pressure, is preferably at least 0.1 MPa, more preferably at least 0.15 MPa, and still more preferably at least 0.2 MPa and is preferably not more than 10 MPa, more preferably not more than 5 MPa, and still more preferably not more than 3 MPa, depending on the operation temperature of Step 4.

Since pressurization is necessary so as to separate hydrogen gas and to recycle hydrosilane to serve as a reaction raw material, it is desirable to perform heating at this stage so that the product or entrained oligosilanes do not condense.

### (Refining Step)

The production method of the present invention may include a refining step (hereinafter may be abbreviated as “refining step”) in which an oligosilane is isolated from the liquid obtained by cooling the high product content fluid obtained in Step 2 and/or the liquid obtained through Step 3. The refining step may not only isolate each oligosilane by separation, but may also isolate each of tetrahydrosilane (SiH₄), an oligosilane with more than 5 silicon atoms, and the like according to the purposes.

The method for isolating an oligosilane in the refining step is not particularly limited, and for example, an oligosilane is isolated by distillation.

In addition to the above-described Steps 1, 2, 3, and 4 and the refining step, the production method of the present invention may also include, for example, a heating step, a cooling step, a pressurizing step, and a depressurizing step for adjusting temperature and pressure for a subsequent step, and a filtering step for separating solids. In a recycling method, the method may include a step of using a compressor or the like to introduce recovered tetrahydrosilane (SiH₄) and the like into a reactor and/or adding a raw material such as additional tetrahydrosilane (SiH₄) and an oligosilane represented by formula (R-1) or (R-2).

When the production method of the present invention is a batch method, examples of the specific aspects of the production method include an aspect in which Steps 1 and 2 and the refining step are included. Step 1 for example uses a batch reactor, and Step 2, the refining step, and the like for example use dedicated batch apparatuses and dedicated batch tools.

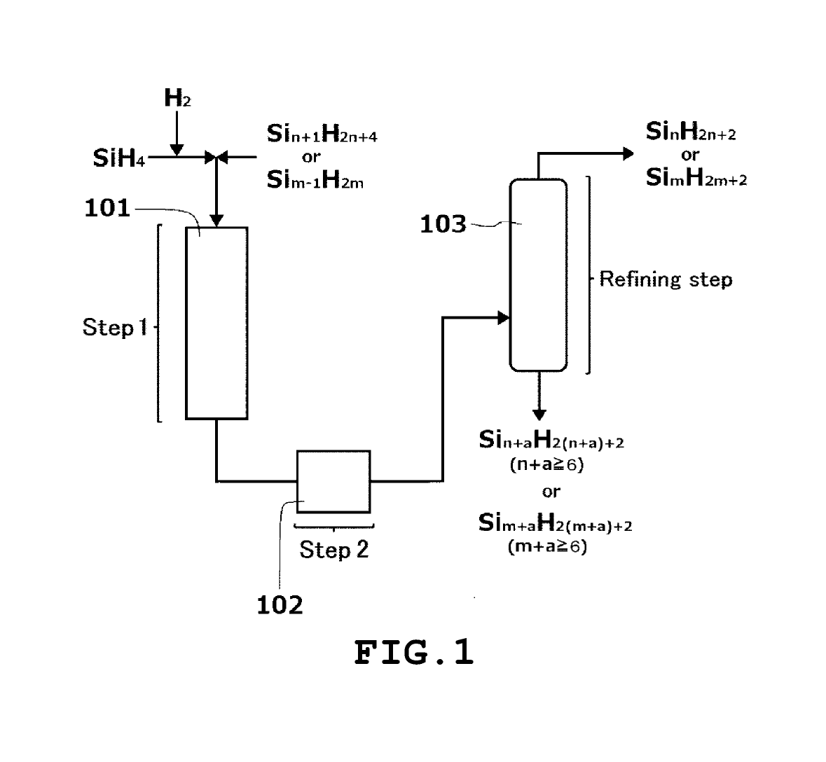

When the production method of the present invention is a continuous one-pass method, examples of the specific aspects of the production method include an aspect in which Steps 1 and 2 and the refining step are included. In such an aspect, for example, an apparatus as shown in FIG. 1 is used. In addition, another aspect of the present invention provides an oligosilane production apparatus as shown in FIG. 1. The configuration of the apparatus in FIG. 1 is described below in detail.

First, raw material gas is pressurized to a predetermined pressure, preheated, and introduced into a reactor 101 set to a predetermined temperature. A reaction-produced mixture fluid reacted here is next sent to a separation unit 102. In doing so, the mixture may be sent to the separation unit 102 through a filter for separating a solid oligosilane(s) in preparation for abnormality. In such a case, for achieving more efficient condensation, it is better to lower the reaction gas temperature with a heat exchanger or the like.

After separation of the reaction-produced mixture fluid, a high product content fluid (liquid) which has a high content of high-boiling components containing a target and by-products and a high raw-material content fluid (gas) which has a high content of a low molecular weight raw material such as tetrahydrosilane are refined in a vaporizer 103 separately from each other. Although FIG. 1 illustrates that the vaporizer 103 is for refining the high product content fluid (liquid), the vaporizer 103 may also be used (used appropriately for different purposes) for refining the high raw-material content fluid (gas). A vaporizer for refining the high product content fluid (liquid) and a vaporizer for refining the high raw-material content fluid (gas) may also be configured to be separately provided. The high raw-material content fluid (gas) is cooled and liquefied in advance when it is refined in a vaporizer.

When an adsorbent is used as a separation unit, generally, heating is performed in desorbing an adsorbate to the adsorbent to recover the adsorbate in a gaseous state. In this case and in the case of a fluid separated by a separation membrane as the separation unit, particularly when the high product content fluid is in a gaseous state, although sometimes already condensed and partially liquefied by standing to cool, the separated fluid needs to be further cooled temporarily before being set to a distillation tower so that most of the separated fluid is condensed.

Refining treatment in the vaporizer 103 may be carried out by a batch operation after the liquid is accumulated to some extent, or the treatment may be carried out continuously.

Since monosilane, disilane, trisilane, tetrasilane, and pentasilane have different boiling points, it is desirable to fractionate necessary silanes by increasing their respective purities through rectification.

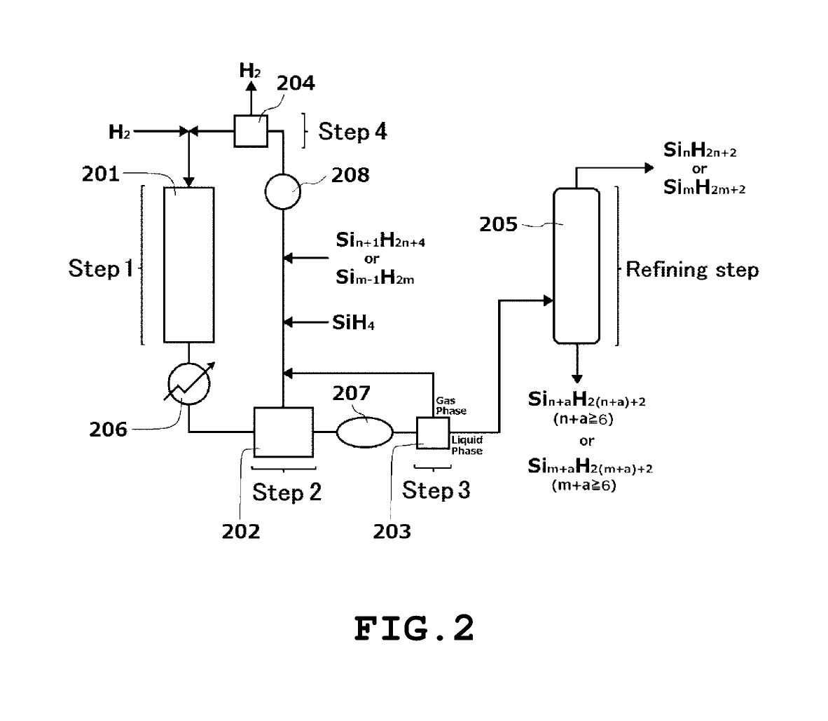

When the production method of the present invention is a continuous recycling method, examples of the specific aspects of the production method include an aspect in which Steps 1, 2, 3 and 4 and the refining step are included, the gas obtained through Step 4 is used for Step 1, and further the liquid containing an oligosilane(s) obtained through Step 3 is subjected to the refining step. In such an aspect, for example, an apparatus as shown in FIG. 2 is used. In addition, another aspect of the present invention provides an oligosilane production apparatus an as shown in FIG. 2. The configuration of the apparatus in FIG. 2 is described below in detail.

First, recycled gas and newly introduced raw material gas are mixed to be a predetermined mixing ratio, then pressurized and preheated as needed, and subsequently introduced into a reactor 201 which is set to a predetermined temperature. With respect to the reaction gas (reaction-produced mixture fluid) discharged from the reactor and containing a product, in the same manner as in a one-pass method, a filter for separation from a solid oligosilane(s) may be provided for responding to abnormality, and thermal energy may be recovered from the reaction gas (reaction-produced mixture fluid) with a heat exchanger 206, which also serves as precooling. The reaction-produced mixture fluid which has been precooled as needed is sent to a separation unit 202 which separates the produced oligosilanes. When recycling, a high raw-material content fluid which has a high content of a low molecular weight raw material such as tetrahydrosilane is recycled as it is or recycled in a gaseous state with heating. The high product content fluid separated by the separation unit 202 is cooled by a cooling unit 207 and turned into a mixture of a fluid containing a target oligosilane and a gas containing raw material gas having been dissolved in the high product content fluid, which are separated from each other by a gas-liquid separation unit 203. From the separated liquid containing an oligosilane(s), a target oligosilane is isolated by a vaporizer 205. The separated gas containing raw material gas is combined with the high raw-material content fluid obtained in Step 2, added with a raw material hydrosilane necessary for recycle introduction into the reactor 201, and pressurized to a reaction pressure by a compressor 208. Hydrogen gas by-produced during the reaction is separated by a hydrogen separation unit 204 (Step 4), and subsequently hydrogen gas is introduced into the reactor 201 as needed such that a predetermined blending ratio is achieved. FIG. 2 illustrates a case where hydrogen gas is introduced. This series of operations is continued for a predetermined reaction time.

Another aspect of the present invention provides an apparatus for more efficiently producing an oligosilane (hereinafter may be abbreviated as “production apparatus of the present invention”).

The production apparatus of the present invention is suitably used for the oligosilane production method which is one aspect of the present invention.

The production apparatus of the present invention includes: a reactor for performing a first step of producing an oligosilane by dehydrogenative coupling of a hydrosilane; a gas-liquid separation unit for performing a second step of separating a reaction-produced mixture fluid obtained through the first step into a high raw-material content fluid and a high product content fluid; and a refining apparatus for distilling a gas-liquid separated liquid, and the apparatus satisfies the following conditions (AA) and/or (BB):

(AA) the gas-liquid separation unit has a membrane separator and is for supplying the reaction-produced mixture fluid to the membrane separator to obtain the high raw-material content fluid as a fluid having permeated through a membrane and obtain the high product content fluid as a fluid having not permeated through the membrane,

(aa-1) the membrane of the membrane separator is made of a zeolite, porous silica, alumina, or zirconia,

(aa-2) the apparatus includes a pressure adjusting unit configured to adjust a pressure of the reaction-produced mixture fluid supplied to the membrane separator to at least 0.1 MPa and not more than 10 MPa, and

(aa-3) the apparatus includes a temperature adjusting unit configured to adjust a temperature of the reaction-produced mixture fluid supplied to the membrane separator to at least −10° C. and less than 300° C.; and

(BB) the gas-liquid separation unit has an adsorbent and is for bringing the reaction-produced mixture fluid into contact with the adsorbent to obtain the high raw-material content fluid as a fluid having not been adsorbed to the adsorbent and obtain the high product content fluid as a fluid having been adsorbed to and subsequently desorbed from the adsorbent,

(bb-1) the adsorbent is made of a zeolite, alumina gel, silica gel, or activated carbon,

(bb-2) the apparatus includes a pressure adjusting unit configured to adjust a pressure of the reaction-produced mixture fluid brought into contact with the adsorbent to at least 0.1 MPa and not more than 20 MPa, and

(bb-3) the apparatus includes a temperature adjusting unit configured to adjust a temperature of the reaction-produced mixture fluid brought into contact with the adsorbent to at least −50° C. and not more than 200° C.

The matters described for the production method of the present invention apply to the oligosilane, the hydrosilane, the first step, the second step, the reaction-produced mixture fluid, the high raw-material content fluid, the high product content fluid, the membrane separator, the adsorbent, and the like of this aspect. The conditions (a-1) to (a-3) correspond to (aa-1) to (aa-3) respectively, and the conditions (b-1) to (b-3) correspond to (bb-1) to (bb-3) respectively.

One embodiment of the production apparatus of the present invention is an apparatus of a continuous one-pass type shown in FIG. 1, and another embodiment is an apparatus of a continuous recycling type shown in FIG. 2.

In the production apparatus of the present invention, examples of a refining apparatus for distilling a gas-liquid separated liquid include a vaporizer. The vaporizer is not particularly limited as long as it is capable of separating an oligosilane by distillation, and a publicly known vaporizer may be used. The vaporizer may be a multi-stage vaporizer or a distillation tower filled with a filler and may contain a rectification apparatus. The temperature adjusting unit is not particularly limited as long as it is capable of adjusting the temperature within the above-described ranges, and examples thereof include a heat exchanger, an electric heating apparatus, and a heating apparatus of a heating medium type.

The pressure adjusting portion is not particularly limited as long as it is capable of adjusting the pressure within the above-described ranges and is for example a compressor (gas pressurizing apparatus), and specific examples thereof include a reciprocating compressor, a swash plate compressor, a diaphragm compressor, a twin screw compressor, a single screw compressor, a scroll compressor, a rotary compressor, a rotary piston compressor, and a slide vane compressor.

It is also preferable that the production apparatus of the present invention further includes a hydrogen separation unit configured to selectively separate hydrogen contained in a gas-liquid separated gas. Examples of the hydrogen separation unit include a hydrogen separation membrane. As the hydrogen separation unit, for example, a hydrogen separation membrane made from ceramic, a hydrogen separation membrane made from polyimide, or a palladium membrane is used. The hydrogen separation unit may be connected to the gas-liquid separation unit so as to be supplied with the high raw-material content fluid obtained in Step 2, may be connected to the gas-liquid separation unit of Step 3 where the high product content fluid is separated into liquid (a gas phase) and gas (a gaseous phase) so as to be supplied with the gas obtained in Step 3, or may be supplied with a mixture of both.

### EXAMPLES

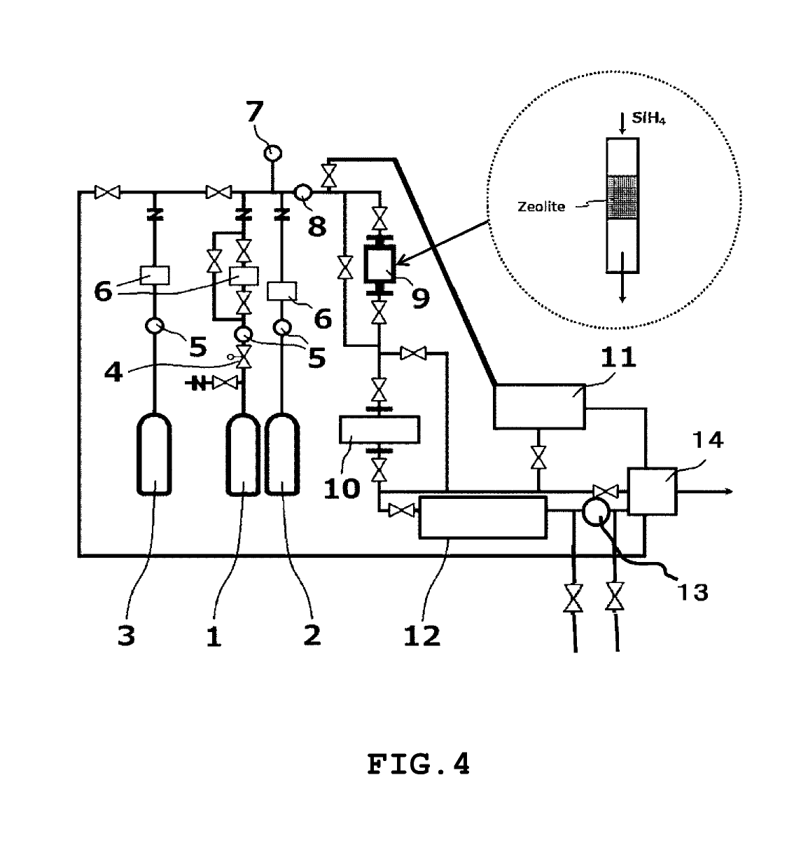

The present invention is described in additional detail using the Examples provided below, but modifications can be made as appropriate insofar as there is no departure from the essential features of the present invention. Accordingly, the scope of the present invention should not be construed as being limited to or by the specific examples given below. The Examples were carried out by immobilizing a zeolite in a fixed bed within a reaction tube of a reaction apparatus shown in FIG. 4 (schematic diagram) and causing a tetrahydrosilane-containing reaction gas diluted with helium gas or the like to flow through. The produced gas was analyzed using a GC-17A gas chromatograph from Shimadzu Corporation with a TCD (Thermal Conductivity Detector). Qualitative analysis of disilane and so forth was performed with a MASS (mass spectrometer).

The pores in the zeolite used as the catalyst are as follows.
H-ZSM-5:

<100> minor diameter=0.51 nm, major diameter=0.55 nm

<010> minor diameter=0.53 nm, major diameter=0.56 nm

The numerical values for the pore minor diameter and major diameter are taken from “http://www.jaz-online.org/introduction/qanda.html” and “ATLAS OF ZEOLITE FRAMEWORK TYPES, Ch. Baerlocher. L. B. McCusker and D. H. Olson, Sixth Revised Edition 2007, published on behalf of the Structure Commission of the International Zeolite Association”.

### Preparative Example of Catalyst: Preparation of Molybdenum(Mo)-Loaded Zeolite Pellets

Distilled water in an amount of 200 g and 3.70 g of (NH₄)₆Mo₇O₂₄.4H₂O (corresponding to a loading of 1 mass % as Mo) were added to 200 g of H-ZSM-5 pellets with a diameter of 3 mm (silica/alumina ratio=23, from Tosoh Corporation, product name: HSZ type 822HOD3A, containing from 18 to 22 mass % alumina (SDS stated value) as a binder) and mixing was carried out for 1 hour at room temperature. Subsequently, the mixture was dried in the atmosphere for 4 hours at 110° C. and then fired in the atmosphere for 2 hours at 400° C. and additional 2 hours at 900° C. to provide 1 mass % Mo-loaded ZSM-5 (pellets).

Distilled water in an amount of 100 g and 2.38 g of Ba(NO₃)₂ (corresponding to a 2.4 mass % loading as Ba) were added to 50 g of the thus-prepared 1 mass % Mo-loaded ZSM-5 (silica/alumina ratio=23) and mixing was carried out for 1 hour at room temperature. This was followed by drying in the atmosphere for 4 hours at 110° C. and then firing in the atmosphere for 2 hours at 700° C., which provided a 1 mass % Mo-loaded ZSM-5 (silica/alumina ratio=23) containing 2.4 mass % of Ba.

### <Example of Pretreatment of Adsorption Tower>

An adsorption tower was filled with 50 g of 3.2 mm ø Molecular Sieve 5 A pellets (from Union Showa K.K.), and heat treatment was performed for 2 hours at 200° C. while reducing the pressure. Subsequently, after cooling to room temperature, the pressure was returned to normal pressure with helium gas, and monosilane (tetrahydrosilane) gas was then caused to flow through at 2 mL/minute for 2 hours under normal pressure and left for 8 hours in monosilane gas atmosphere. Then, adsorbed monosilane gas was forced out by depressurization, and the pressure was returned to normal pressure with helium gas. This treatment inactivated functional groups such as silanol groups which were on the surface of Molecular Sieve 5 A and reactive with silanes.

### Example 1

The catalyst prepared in the preparative example and in an amount of 1.0 g was placed in a reaction tube, and the air was removed from the reaction tube using a vacuum pump, which was followed by substitution with helium gas. The helium gas was caused to flow through at a rate of 5 mL/minute, and a tubular furnace was set to 200° C. to raise the temperature of the reaction tube, after which throughflow was performed for 1 hour. Then, bypassing the adsorption tower, an argon/tetrahydrosilane mixed gas (Ar: 20%, SiH₄: 80% (molar ratio)) at 2 mL/minute, hydrogen gas at 2 mL/minute, and helium gas at 1 mL/minute were mixed in a gas mixer and caused to flow through at a reaction pressure of 0.3 MPa (absolute pressure) (gauge pressure: 0.2 MPa). After 5 minutes, the argon/silane mixed gas was brought to 3 mL/minute, the hydrogen gas was brought to 1 mL/minute, and the helium gas was stopped. The flow rates were controlled with mass flow controllers, the numerical values are for converted volume at 0° C., 1 atmospheric pressure, and the residence time was 21 seconds. After the reaction was run in this state for 4 hours, the reaction gas was caused to flow through the adsorption tower which had been made ice cold, while being maintained at 0.3 MPa (absolute pressure) (gauge pressure: 0.2 MPa). After 7 hours, bypassing the adsorption tower again, the reaction gas was caused to directly flow out of the system, and the reaction was terminated in 8 hours.

Table 1 shows analysis values of the reaction gas (reaction-produced mixture fluid) which could not been adsorbed to the adsorption tower after the helium gas was stopped. The analysis values for from 1 to 4 hours later and 8 hours later are analysis values for the reaction gas itself (reaction-produced mixture fluid) because the adsorption tower was bypassed (the molar concentration of disilane in all silanes was 4.67 mol % on average), whereas the analysis values for from 5 to 7 hours later are analysis values for the reaction gas (high raw-material content fluid) which could not be adsorbed to the adsorption tower (the molar concentration of disilane in all silanes was 0.50 mol % on average), each of which is shown in molar concentration.

“Monosilane/All silanes” in the table is obtained by dividing the molar concentration of monosilane by the sum total of the molar concentrations of detectable silanes.

After the reaction was terminated, the reaction gas components adsorbed to the adsorption tower were desorbed by heating to 100° C. under normal pressure, and the desorbed gas was trapped at liquid nitrogen temperature. The analysis of the components of the desorbed gas (trapped gas) gave the following results: tetrahydromonosilane: 0.248 g, hexahydrodisilane: 0.054 g, an oligosilane with 3 to 5 silicon atoms: 0.005 g, the molar concentration of oligosilanes (disilane+the oligosilane with 3 to 5 silicon atoms) in the detected silanes: 10.6 mol %. No higher-order silane with 6 or more silicon atoms was detected.

TABLE 1

| | | | | | Concentrations in Gas (mol %) | | | | | |
|---|---|---|---|---|---|---|---|---|---|---|
| Reaction | | | | | | | Oligosilane | Monosilane/ | Disilane/ | Oligosilane/ |
| Temperature | Time | Flow Rate (mL/min.) | | | | | with 3 to 5 Si | All Silanes | All Silanes | All Silanes |
| (° C.) | (h) | Silane | Ar | Hydrogen | Monosilane | Disilane | Atoms | (mol %) | (mol %) | (mol %) |
| 200 | 1 | 2.4 | 0.6 | 1.0 | 50.2 | 2.3 | 0.6 | 94.6 | 4.33% | 5.4 |
| 200 | 2 | 2.4 | 0.6 | 1.0 | 52.4 | 2.6 | 0.4 | 94.6 | 4.69% | 5.4 |
| 200 | 3 | 2.4 | 0.6 | 1.0 | 54.6 | 2.7 | 0.2 | 95.0 | 4.70% | 5.0 |
| 200 | 4 | 2.4 | 0.6 | 1.0 | 55.2 | 2.8 | 0.2 | 95.0 | 4.81% | 5.0 |
| 200 | 5 | 2.4 | 0.6 | 1.0 | 39.1 | 0.2 | 0.0 | 99.5 | 0.50% | 0.5 |
| 200 | 6 | 2.4 | 0.6 | 1.0 | 39.2 | 0.2 | 0.0 | 99.5 | 0.50% | 0.5 |
| 200 | 7 | 2.4 | 0.6 | 1.0 | 39.8 | 0.2 | 0.0 | 99.5 | 0.50% | 0.5 |
| 200 | 8 | 2.4 | 0.6 | 1.0 | 55.2 | 2.8 | 0.2 | 94.9 | 4.81% | 5.1 |

Concentrations of silanes in desorbed gas: monosilane (89.3 mol %), disilane (10.0 mol %), oligosilane with 3 to 5 Si atoms (0.6 mol %)

### Example 2

Example 2 was carried out in the same manner as in Example 1, except that the cooling temperature in an adsorption tower 12 shown in FIG. 4 was 50° C. The results are given in Table 2.

TABLE 2

| | | | | | Concentrations in Gas (mol %) | | | | | |
|---|---|---|---|---|---|---|---|---|---|---|
| Reaction | | | | | | | Oligosilane | Monosilane/ | Disilane/ | Oligosilane/ |
| Temperature | Time | Flow Rate (mL/min.) | | | | | with 3 to 5 Si | All Silanes | All Silanes | All Silanes |
| (° C.) | (h) | Silane | Ar | Hydrogen | Monosilane | Disilane | Atoms | (mol %) | (mo1%) | (mol %) |
| 200 | 1 | 2.4 | 0.6 | 1.0 | 50.2 | 2.3 | 0.6 | 94.6 | 4.33 | 5.4 |
| 200 | 2 | 2.4 | 0.6 | 1.0 | 52.3 | 2.6 | 0.4 | 94.5 | 4.70 | 5.5 |
| 200 | 3 | 2.4 | 0.6 | 1.0 | 54.6 | 2.7 | 0.2 | 95.0 | 4.70 | 5.0 |
| 200 | 4 | 2.4 | 0.6 | 1.0 | 55.2 | 2.8 | 0.2 | 95.0 | 4.81 | 5.0 |
| 200 | 5 | 2.4 | 0.6 | 1.0 | 45.9 | 0.7 | 0.0 | 98.5 | 1.50 | 1.5 |
| 200 | 6 | 2.4 | 0.6 | 1.0 | 46.0 | 0.7 | 0.0 | 98.4 | 1.50 | 1.6 |
| 200 | 7 | 2.4 | 0.6 | 1.0 | 46.6 | 0.7 | 0.0 | 98.5 | 1.48 | 1.5 |
| 200 | 8 | 2.4 | 0.6 | 1.0 | 55.0 | 2.8 | 0.2 | 94.8 | 4.83 | 5.2 |

Concentrations of silanes in desorbed gas: monosilane (81.2 mol %), disilane (17.6 mol %), oligosilane with 3 to 5 Si atoms (1.1 mol %)

The reaction gas trapped in the same manner was as follows: tetrahydromonosilane: 0.102 g, hexahydrodisilane: 0.043 g, an oligosilane with 3 to 5 silicon atoms: 0.004 g, the molar concentration of oligosilanes (disilane+the oligosilane with 3 to 5 silicon atoms) in the detected silanes: 18.7 mol %. As in Example 1, no higher-order silane with 6 or more silicon atoms was detected.

### Example 3

Example 3 was carried out in the same manner as in Example 1, except that the adsorbent was changed from Molecular Sieve 5 A (from Union Showa K.K.) to silica gel CARiACT Q-10 (from Fuji Silysia Chemical Ltd., in an approximately 3-mm ø spherical shape with a specific surface area of 304 m²/g (catalog value)). The results are given in Table 3.

TABLE 3

| | | | | | Concentrations in Gas (mol %) | | | | | |
|---|---|---|---|---|---|---|---|---|---|---|
| Reaction | | | | | | | Oligosilane | Monosilane/ | Disilane/ | Oligosilane/ |
| Temperature | Time | Flow Rate (mL/min.) | | | | | With 3 to 5 Si | All Silanes | All Silanes | All Silanes |
| (° C.) | (h) | Silane | Ar | Hydrogen | Monosilane | Disilane | Atoms | (mol %) | (mol %) | (mol %) |
| 200 | 1 | 2.4 | 0.6 | 1.0 | 50.3 | 2.3 | 0.6 | 94.6 | 4.32 | 5.4 |
| 200 | 2 | 2.4 | 0.6 | 1.0 | 52.3 | 2.6 | 0.4 | 94.5 | 4.70 | 5.5 |
| 200 | 3 | 2.4 | 0.6 | 1.0 | 54.6 | 2.7 | 0.2 | 95 0 | 4.70 | 5.0 |
| 200 | 4 | 2.4 | 0.6 | 1.0 | 55.2 | 2.8 | 0.2 | 95.0 | 4.81 | 5.0 |
| 200 | 5 | 2.4 | 0.6 | 1.0 | 43.5 | 0.4 | 0.0 | 99.2 | 0.91 | 0.8 |
| 200 | 6 | 2.4 | 0.6 | 1.0 | 43.6 | 0.4 | 0.0 | 99.1 | 0.91 | 0.9 |
| 200 | 7 | 2.4 | 0.6 | 1.0 | 44.1 | 0.4 | 0.0 | 99.1 | 0.90 | 0.9 |
| 200 | 8 | 2.4 | 0.6 | 1.0 | 55.1 | 2.8 | 0.2 | 94.9 | 4.82 | 5.1 |

Concentrations of silanes in desorbed gas: monosilane (88.3 mol %), disilane (10.9 mol %), oligosilane with 3 to 5 Si atoms (0.7 mol %)

The reaction gas trapped in the same manner was as follows: tetrahydromonosilane: 0.217 g, hexahydrodisilane: 0.052 g, an oligosilane with 3 to 5 silicon atoms: 0.005 g, the molar concentration of oligosilanes (disilane+the oligosilane with 3 to 5 silicon atoms) in the detected silanes: 11.6 mol %. As in Example 1, no higher-order silane with 6 or more silicon atoms was detected.

### Comparative Example 1

Comparative Example 1 was carried out in the same manner as in Example 1, except that no adsorbent was placed in the adsorption tower 12 shown in FIG. 4. The results are given in Table 4.

TABLE 4

| | | | | | Concentrations in Gas (mol %) | | | | | |
|---|---|---|---|---|---|---|---|---|---|---|
| Reaction | | | | | | | Oligosilane | Monosilane/ | Disilane/ | Oligosilane/ |
| Temperature | Time | Flow Rate (mL/min.) | | | | | with 3 to 5 Si | All Silanes | All Silanes | All Silanes |
| (° C.) | (h) | Silane | Ar | Hydrogen | Monosilane | Disilane | Atoms | (mol %) | (mol %) | (mol %) |
| 200 | 1 | 2.4 | 0.6 | 1.0 | 50.2 | 2.4 | 0.6 | 94.4 | 4.51 | 5.6 |
| 200 | 2 | 2.4 | 0.6 | 1.0 | 52.2 | 2.7 | 0.4 | 94.4 | 4.88 | 5.6 |
| 200 | 3 | 2.4 | 0.6 | 1.0 | 54.6 | 2.7 | 0.2 | 94.9 | 4.70 | 5.1 |
| 200 | 4 | 2.4 | 0.6 | 1.0 | 55.2 | 2.7 | 0.2 | 95.0 | 4.65 | 5.0 |
| 200 | 5 | 2.4 | 0.6 | 1.0 | 54.7 | 2.9 | 0.2 | 94 6 | 4.93 | 5.4 |
| 200 | 6 | 2.4 | 0.6 | 1.0 | 54.7 | 2.9 | 0.2 | 94.7 | 4.93 | 5.3 |
| 200 | 7 | 2.4 | 0.6 | 1.0 | 55.1 | 2.8 | 0.2 | 94.9 | 4.82 | 5.1 |
| 200 | 8 | 2.4 | 0.6 | 1.0 | 55.2 | 2.8 | 0.2 | 95.0 | 4.81 | 5.0 |

In Comparative Example 1, since no adsorbent was placed in the adsorption tower, that is, since the reaction did not go through Step 2, after the reaction was terminated, there was no reaction gas trapped to the adsorption tower.

### Comparative Example 2

Comparative Example 2 was carried out in the same manner as in Example 1, except that the adsorbent of Example 1 was replaced with 3 mm ø glass beads (soda glass from AS ONE corporation, BZ-3). The results are given in Table 5.

TABLE 5

| | | | | | Concentrations in Gas (mol %) | | | | | |
|---|---|---|---|---|---|---|---|---|---|---|
| Reaction | | | | | | | Oligosilane | Monosilane/ | Disilane/ | Oligosilane/ |
| Temperature | Time | Flow Rate (mL/min.) | | | | | with 3 to 5 Si | All Silanes | All Silanes | All Silanes |
| (° C.) | (h) | Silane | Ar | Hydrogen | Monosilane | Disilane | Atoms | (mol %) | (mol %) | (mol %) |
| 200 | 1 | 2.4 | 0.6 | 1.0 | 50.3 | 2.4 | 0.6 | 94.4 | 4.50 | 5.6 |
| 200 | 2 | 2.4 | 0.6 | 1.0 | 52.5 | 2.6 | 0.4 | 94.6 | 4.68 | 5.4 |
| 200 | 3 | 2.4 | 0.6 | 1.0 | 54.6 | 2.7 | 0.2 | 94.9 | 4.70 | 5.1 |
| 200 | 4 | 2.4 | 0.6 | 1.0 | 55.2 | 2.7 | 0.2 | 95.0 | 4.65 | 5.0 |
| 200 | 5 | 2.4 | 0.6 | 1.0 | 50.6 | 2.4 | 0.1 | 95.4 | 4.52 | 4.6 |
| 200 | 6 | 2.4 | 0.6 | 1.0 | 50.6 | 2.4 | 0.1 | 95.3 | 4 52 | 4.7 |
| 200 | 7 | 2.4 | 0.6 | 1.0 | 50.7 | 2.5 | 0.1 | 95.2 | 4.69 | 4.8 |
| 200 | 8 | 2.4 | 0.6 | 1.0 | 54.9 | 2.9 | 0.2 | 94.7 | 5.00 | 5.3 |

In Comparative Example 2, glass beads having a small specific surface area were placed in the adsorption tower, and the trapped reaction gas, which was in a small amount and thus probably had large measurement errors, was as follows: tetrahydromonosilane: 0.005 g, hexahydrodisilane: 0.0001 g, an oligosilane with 3 to 5 silicon atoms: below the detection limit and could not be efficiently separated.

These results demonstrate that since the components adsorbed to the adsorption tower (high product content fluid) had an increased concentration of disilane, namely a target than that in the reaction gas (reaction-produced mixture fluid), the energy required for cooling prior to the distillation refining step is less than when totally condensing the reaction gas (reaction-produced mixture fluid), whereby costs associated with refining is significantly reduced. The results also demonstrate that when an adsorption tower was used, that is, when Step 2 was carried out, the monosilane concentration in an unadsorbed gas (high raw-material content fluid) of the reaction gas (reaction-produced mixture fluid) was at least 98 mol %, which makes it possible to recycle the unadsorbed reaction gas as it is. Hence, with the production method of the present invention, the energy required for oligosilane refining can be reduced, and costs can be reduced. In addition, since a raw material can have a high concentration in a high raw-material content fluid, the high raw-material content fluid can be reused as it is, whereby the total energy required for oligosilane production can be further reduced, and costs can be reduced.

### INDUSTRIAL APPLICABILITY

Oligosilanes produced by the production method of the present invention are expected to be used as a gas for the production of silicon for semiconductors.

### REFERENCE SIGNS LIST

1 Tetrahydrosilane gas cylinder (containing 20 mol % Ar)
2 Hydrogen gas cylinder
3 Helium gas cylinder
4 Emergency shutoff valve (shutoff valve linked with gas detection)
Pressure reduction valve
6 Mass flow controller
7 Pressure gauge
8 Gas mixer
9 Reaction tube
10 Filter
11 Rotary pump
12 Adsorption tower
13 Secondary pressure adjustment valve
14 Abatement apparatus
101, 201 Reactor
102, 202 Separation unit
103, 205 Vaporizer
203 Gas-liquid separation unit
204 Hydrogen separation unit
206 Heat exchanger
207 Cooling unit
208 Compressor

1. A method for producing an oligosilane, comprising:
a first step of producing an oligosilane by dehydrogenative coupling of a hydrosilane; and
a second step of separating a reaction-produced mixture fluid obtained through the first step into a high raw-material content fluid and a high product content fluid by subjecting the reaction-produced mixture fluid to the following treatments (A) and/or (B), wherein
a molar concentration of an oligosilane with at least 2 and not more than 5 silicon atoms with respect to all silane compounds in the high raw-material content fluid is lower than a molar concentration of the oligosilane with at least 2 and not more than 5 silicon atoms with respect to all silane compounds in the reaction-produced mixture fluid, and
a molar concentration of the oligosilane with at least 2 and not more than 5 silicon atoms with respect to all silane compounds in the high product content fluid is higher than the molar concentration of the oligosilane with at least 2 and not more than 5 silicon atoms with respect to all silane compounds in the reaction-produced mixture fluid,
(A) supplying the reaction-produced mixture fluid to a membrane separator under conditions satisfying the following (a-1) to (a-3) to obtain the high raw-material content fluid as a fluid having permeated through a membrane and obtain the high product content fluid as a fluid having not permeated through the membrane:
(a-1) the membrane of the membrane separator is made of a zeolite, porous silica, alumina, or zirconia;
(a-2) the reaction-produced mixture fluid supplied to the membrane separator has a pressure of at least 0.1 MPa and not more than 10 MPa; and
(a-3) the reaction-produced mixture fluid supplied to the membrane separator has a temperature of at least −10° C. and less than 300° C., and
(B) bringing the reaction-produced mixture fluid into contact with an adsorbent under conditions satisfying the following (b-1) to (b-3) to obtain the high raw-material content fluid as a fluid having not been adsorbed to the adsorbent and obtain the high product content fluid as a fluid having been adsorbed to and subsequently desorbed from the adsorbent:
(b-1) the adsorbent is made of a zeolite, alumina gel, silica gel, or activated carbon;
(b-2) the reaction-produced mixture fluid brought into contact with the adsorbent has a pressure of at least 0.1 MPa and not more than 20 MPa; and
(b-3) the reaction-produced mixture fluid brought into contact with the adsorbent has a temperature of at least −50° C. and not more than 200° C.

2. The method for producing an oligosilane according to claim 1, wherein
in the first step, the hydrosilane is tetrahydrosilane (SiH₄), and the produced oligosilane includes hexahydrodisilane (Si₂H₆).

3. The method for producing an oligosilane according to claim 1, wherein
the method is for producing an oligosilane represented by the following formula (P-1), and
in the first step, the oligosilane represented by formula (P-1) is produced from an oligosilane represented by the following formula (R-1) using the oligosilane represented by formula (R-1) as a raw material hydrosilane together with tetrahydrosilane (SiH₄):
SiₙH₂ₙ₊₂ (P-1)
where n represents an integer of from 2 to 5, 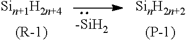
where n represents an integer of from 2 to 5.

4. The method for producing an oligosilane according to claim 3, wherein
the oligosilane represented by formula (R-1) is octahydrotrisilane (Si₃H₈), and
the oligosilane represented by formula (P-1) is hexahydrodisilane (Si₂H₆).

5. The method for producing an oligosilane according to claim 1, wherein
the method is for producing an oligosilane represented by the following formula (P-2), and
in the first step, the oligosilane represented by formula (P-2) is produced from an oligosilane represented by the following formula (R-2) using the oligosilane represented by formula (R-2) as a raw material hydrosilane together with tetrahydrosilane (SiH₄):
SiₘH₂ₘ₊₂ (P-2)
where m represents an integer of from 3 to 5, 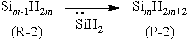
where m represents an integer of from 3 to 5.

6. The method for producing an oligosilane according to claim 5, wherein
the oligosilane represented by formula (R-2) is hexahydrodisilane (Si₂H₆), and
the oligosilane represented by formula (P-2) is octahydrotrisilane (Si₃H₈).

7. The method for producing an oligosilane according to claim 1, wherein
the membrane used in the treatment (A) has a pore diameter of at least 0.1 nm and not more than 100 μm.

8. The method for producing an oligosilane according to claim 1, wherein
the adsorbent used in the treatment (B) has a BET specific surface area of at least 10 m²/g and not more than 1,000 m²/g.

9. The method for producing an oligosilane according to claim 1, wherein
the first step is carried out in the presence of hydrogen gas.

10. The method for producing an oligosilane according to claim 1, wherein
the first step is carried out in the presence of a catalyst containing a transition element.

11. The method for producing an oligosilane according to claim 10, wherein
the transition element contained in the catalyst is at least one transition element selected from the group consisting of group 4 transition elements, group 5 transition elements, group 6 transition elements, group 7 transition elements, group 8 transition elements, group 9 transition elements, group 10 transition elements, and group 11 transition elements.

12. The method for producing an oligosilane according to claim 10, wherein
the catalyst is a heterogeneous catalyst containing a support.

13. The method for producing an oligosilane according to claim 12, wherein
the support is at least one selected from the group consisting of silica, alumina, and zeolites.

14. The method for producing an oligosilane according to claim 13, wherein
the zeolite has pores with a minor diameter of at least 0.41 nm and a major diameter of not more than 0.74 nm.

15. The method for producing an oligosilane according to claim 1, wherein
the method is a one-pass method where the first step is carried out only once.

16. The method for producing an oligosilane according to claim 1, wherein
the method is a recycling method where at least part of unreacted tetrahydrosilane (SiH₄) is resupplied and reused as a raw material in the first step.

17. The method for producing an oligosilane according to claim 3, wherein
the method is a recycling method where at least part of unreacted tetrahydrosilane (SiH₄) is resupplied and reused as a raw material in the first step.

18. The method for producing an oligosilane according to claim 17, wherein
the method is a recycling method where further at least part of the oligosilane represented by formula (R-1) or the oligosilane represented by formula (R-2) is resupplied and reused as a raw material in the first step.

19. The method for producing an oligosilane according to claim 17, further comprising a step of separating hydrogen gas using a hydrogen separating membrane from the high raw-material content fluid obtained through the second step.

20. An apparatus for producing an oligosilane, comprising:
a reactor for performing a first step of producing an oligosilane by dehydrogenative coupling of a hydrosilane;
a gas-liquid separation unit for performing a second step of separating a reaction-produced mixture fluid obtained through the first step into a high raw-material content fluid and a high product content fluid; and
a refining apparatus for distilling a gas-liquid separated liquid, wherein
the apparatus satisfies the following conditions (AA) and/or (BB):
(AA) the gas-liquid separation unit has a membrane separator and is for supplying the reaction-produced mixture fluid to the membrane separator to obtain the high raw-material content fluid as a fluid having permeated through a membrane and obtain the high product content fluid as a fluid having not permeated through the membrane,
(aa-1) the membrane of the membrane separator is made of a zeolite, porous silica, alumina, or zirconia,
(aa-2) the apparatus comprises a pressure adjusting unit configured to adjust a pressure of the reaction-produced mixture fluid supplied to the membrane separator to at least 0.1 MPa and not more than 10 MPa, and
(aa-3) the apparatus comprises a temperature adjusting unit configured to adjust a temperature of the reaction-produced mixture fluid supplied to the membrane separator to at least −10° C. and less than 300° C.; and
(BB) the gas-liquid separation unit has an adsorbent and is for bringing the reaction-produced mixture fluid into contact with the adsorbent to obtain the high raw-material content fluid as a fluid having not been adsorbed to the adsorbent and obtain the high product content fluid as a fluid having been adsorbed to and subsequently desorbed from the adsorbent,
(bb-1) the adsorbent is made of a zeolite, alumina gel, silica gel, or activated carbon,
(bb-2) the apparatus comprises a pressure adjusting unit configured to adjust a pressure of the reaction-produced mixture fluid brought into contact with the adsorbent to at least 0.1 MPa and not more than 20 MPa, and
(bb-3) the apparatus comprises a temperature adjusting unit configured to adjust a temperature of the reaction-produced mixture fluid brought into contact with the adsorbent to at least −50° C. and not more than 200° C.

21. The apparatus for producing an oligosilane according to claim 20, further comprising a hydrogen separation unit configured to selectively separate hydrogen contained in a gas-liquid separated gas.

22. The method for producing an oligosilane according to claim 16, further comprising a step of separating hydrogen gas using a hydrogen separating membrane from the high raw-material content fluid obtained through the second step.
